(19) United States
(12) Patent Application Publication
(10) Pub. No.: US 2025/0292687 A1
(43) Pub. Date: Sep. 18, 2025

(54) ENVIRONMENTAL TEXT PERCEPTION AND TOLL EVALUATION USING VISION LANGUAGE MODELS

(71) Applicant: NVIDIA CORPORATION, Santa Clara, CA (US)

(72) Inventors: Niral Lalit Pathak, Santa Clara, CA (US); Chandana Neerukonda, Fremont, CA (US); Rajath Bellipady Shetty, Sunnyvale, CA (US); Niranjan Avadhanam, Saratoga, CA (US); Ratin Kumar, Cupertino, CA (US)

(21) Appl. No.: 18/791,995

(22) Filed: Aug. 1, 2024

Related U.S. Application Data
(60) Provisional application No. 63/566,731, filed on Mar. 18, 2024.
(60) Provisional application No. 63/566,798, filed on Mar. 18, 2024.

(51) Int. Cl. G08G 1/16; G01C 21/34; G06V 20/58

(52) U.S. Cl. CPC G08G 1/167; G01C 21/3461; G06V 20/582

(57) ABSTRACT

A vision language model (VLM) may be used to evaluate signs that designate restricted or toll lanes, determine whether it is permissible (and/or the cost) to merge into a restricted or toll lane, and/or determine when to merge out of a restricted or toll lane based on the cost. Frames from one or more (e.g., front-facing) camera(s) may be evaluated for applicable signs (e.g., using a sign recognition DNN or a VLM). If detected, the (e.g., cropped) image of the sign may be provided as input to a VLM with a textual prompt instructing the VLM to determine whether to drive in the restricted or toll lane (e.g., whether it can be taken within budget) and/or what the cost would be. The generated response may be provided to an ADAS to trigger an initiation of a merge left or right or a determination to stay in the current lane.

### CROSS-REFERENCE TO RELATED APPLICATIONS

This application claims the benefit of U.S. Provisional Application No. 63/566,731 filed on Mar. 18, 2024, and U.S. Provisional Application No. 63/566,798 filed on Mar. 18, 2024, each of which is hereby incorporated by reference in its entirety.

### BACKGROUND

In modern vehicles and other ego-machines, deep neural networks (DNNs) and computer vision (CV) are often used to provide a range of advanced functionalities. For example, DNNs and CV may be used by autonomous and semi-autonomous vehicles for tasks such as object detection, traffic sign recognition, driver and occupant monitoring, and trajectory planning, among other things. Ego-machines often rely on multiple DNNs working in concert, with different networks specializing in different tasks.

For example, driver monitoring systems (DMS) and occupant monitoring systems (OMS) are being increasingly made available in modern vehicles to ensure the driver remains alert and to enhance the safety of occupants and other road users. Some example driver monitoring tasks include driver distraction detection, driver drowsiness detection, and driver out-of-position (not drive-ready) detection. Some example occupant monitoring tasks include child presence detection, occupant out-of-position (occupant in an unsafe position), distress detection, and monitoring seatbelt usage. Many of these tasks, such as driver distraction and driver drowsiness detection, are time-sensitive and should be detected as soon as possible to warn the driver about potential safety incidents. Traditionally, driver and occupant monitoring systems use cameras oriented towards the interior of the vehicle and vision modules that use DNNs and CV techniques to trigger corresponding actions or behaviors by the vehicle. These conventional detection pipelines typically require multiple DNNs each, and the DNN outputs need to be processed and interpreted through predefined algorithms and rules to produce a precise, actionable outcome or decision.

Taking a conventional, multi-stage, driver drowsiness detection pipeline as an example, an initial DNN performs facial detection to identify and isolate the driver's face from an image. Next, another DNN performs facial landmark detection from a given face crop, and the detected facial landmarks are applied to an eye state classification DNN that evaluates whether the eyes are open or closed and estimates the degree of eyelid droopiness. Concurrently, a head pose estimation DNN assesses the driver's head position and movements, which can be indicative of drowsiness. Furthermore, a facial expression recognition DNN analyzes micro-expressions and overall facial muscle activity to detect signs of fatigue. Finally, these outputs may be applied to a decision-making DNN that aggregates the data from the previous networks, applies temporal analysis through techniques like recurrent neural networks (RNNs) to observe patterns over time, and calculates a Karolinska Sleepiness Scale (KSS) level representing the driver's drowsiness state.

Conventional OMS tasks can also involve multiple cascaded DNNs and CV blocks. Taking a conventional, multi-stage, child presence detection pipeline as an example, initially, an occupant detection DNN monitors the vehicle interior to identify the presence of any occupants. Once occupants are detected, a classification DNN differentiates between adults and children based on size, shape, and seating posture. A separate child detection DNN may be used to monitor specific characteristics associated with children such as smaller body proportions. Concurrently, a pose estimation DNN assesses the posture and positioning of detected occupants to detect any movements that are characteristic of children. Additionally, an object detection DNN might verify the presence of objects commonly associated with children (e.g., child seats) to corroborate the findings. The outputs from these networks may be aggregated by a decision-making DNN that synthesizes the information from the different signals and confirms the presence of a child, triggering appropriate alerts or safety protocols.

In another example, there is a growing need to understand environmental text such as signage (e.g., parking signs, road diversion signs, signs that designate restricted or toll lanes, etc.) conveying information pertaining to machines (e.g., vehicles). Traffic sign recognition systems typically use DNNs trained on large datasets of sign images to accurately recognize and interpret various road signs. Traditionally, these systems use cameras oriented towards the exterior of the vehicle and vision modules that use DNNs and CV techniques to trigger corresponding actions or behaviors by the vehicle. Current detection pipelines break tasks like these down into multiple CV blocks to detect the relevant portion of the image where the sign is present, classify the sign, and perform optical character recognition (OCR) to extract the text. The output of conventional detection pipelines also need to be processed and interpreted through predefined algorithms and rules to produce a precise, actionable outcome or decision.

Overall, many tasks performed by autonomous vehicles, semi-autonomous vehicles, autonomous robots, and other ego-machines involve multiple DNNs and/or CV blocks. However, each successive DNN and/or CV block leads to increased processing power, latency, and computational complexity. Furthermore, each individual stage has limited context, as it typically only has access to the outputs of the previous stages rather than all potentially relevant input data, potentially leading to less informed decisions. As such, there is a need for improved techniques for performing exterior and interior monitoring and sensing tasks.

### SUMMARY

Embodiments of the present disclosure relate to driver monitoring, occupant monitoring, and/or environmental text perception using vision language models.

For example, some embodiments relate to driver or occupant monitoring using vision language models (VLMs). Any number of DNNs in a detection pipeline may be replaced with a VLM, and the VLM may be prompted to determine whether a corresponding feature is present in an image or in one or more sampled frames from a video. To facilitate using the VLM(s) to control one or more downstream actions, the VLM(s) may be prompted using structured inputs, and a designated output format for a corresponding structured output may be enforced in any suitable manner. As such, any number of VLMs may be used to perform any number of driver and/or occupant monitoring tasks (e.g., driver drowsiness detection, driver distraction detection, driver or occupant out-of-position detection, driver or occupant identification, seatbelt usage detection, occupant presence detection, occupant classification, child presence detection, gesture recognition, occlusion detection, and/or others).

Some embodiments relate to environmental text perception using VLMs. For example, an Advanced Driver Assistance System (ADAS) may identify candidate parking spaces, and a VLM may be used to evaluate parking signs and determine whether it is permissible and/or the cost to park in a candidate parking space. For example, frames from corresponding (e.g., front-facing, repeater, side pillar) camera(s) may be evaluated for corresponding parking signs (e.g., using a sign recognition DNN or a VLM). If a parking sign is detected, the (e.g., cropped) image of the sign may be provided as input to a VLM with a textual prompt instructing the VLM to determine whether it is permissible to park at a corresponding location (and if so, the cost). The generated response may be provided to the ADAS to confirm or invalidate the candidate parking space, and a representation of the results may be provided to the driver.

In some embodiments, a vision language model (VLM) may be used to evaluate signs that designate restricted or toll lanes, determine whether it is permissible (and/or the cost) to merge into a restricted or toll lane, and/or determine when to merge out of a restricted or toll lane based on the cost. Frames from one or more (e.g., front-facing) camera(s) may be evaluated for applicable signs (e.g., using a sign recognition DNN or a VLM). If detected, the (e.g., cropped) image of the sign may be provided as input to a VLM with a textual prompt instructing the VLM to determine whether to drive in the restricted or toll lane (e.g., whether it can be taken within budget) and/or what the cost would be. The generated response may be provided to an ADAS to trigger an initiation of a merge left or right or a determination to stay in the current lane.

In some embodiments, the same vision language model (VLM) may be used to support different types of detection tasks (e.g., one foundational VLM supporting some or all detection tasks performed by an ego-machine, one VLM for interior sensing tasks and one for exterior sensing tasks, etc.), and an inference scheduler may be used to serve or handle inference requests for the VLM(s) to perform the different tasks. In some embodiments, the scheduler prioritizes inference requests based on safety (e.g., prioritizing inference requests to perform ADAS tasks such as pedestrian detection, bicycle detection, or trajectory planning over requests to perform driver or occupant monitoring tasks, prioritizing exterior sensing tasks over interior sensing tasks, etc.). As such, the scheduler may queue, manage, distribute inference requests from different detection applications to the VLM(s), and receive and return responses to corresponding detection task managers.

As such, the present techniques may be used to increase the accuracy of various driver monitoring, occupant monitoring, and/or environmental text perception tasks using VLMs.

### BRIEF DESCRIPTION OF THE DRAWINGS

The present systems and methods for driver monitoring, occupant monitoring, and/or environmental text perception using vision language models are described in detail below with reference to the attached drawing figures, wherein:

FIG. 1 is a block diagram illustrating an example detection pipeline, in accordance with some embodiments of the present disclosure;

FIG. 2 is a data flow diagram illustrating an example driver distraction detection technique using a vision language model, in accordance with some embodiments of the present disclosure;

FIG. 3A is a data flow diagram illustrating an example parking sign evaluation pipeline, and FIG. 3B illustrates an example parking sign, in accordance with some embodiments of the present disclosure;

FIG. 4A is a data flow diagram illustrating an example toll sign evaluation pipeline, and FIG. 4B illustrates an example toll sign, in accordance with some embodiments of the present disclosure;

FIG. 5 illustrates an example training technique, in accordance with some embodiments of the present disclosure;

FIG. 6 is a flow diagram showing a method for evaluating whether one or more conditions associated with at least one of an operator or an occupant are detected in one or more frames of image data, in accordance with some embodiments of the present disclosure;

FIG. 7 is a flow diagram showing a method for evaluating whether it is permissible to park in one or more candidate parking spaces, in accordance with some embodiments of the present disclosure;

FIG. 8 is a flow diagram showing a method for evaluating whether to drive in one or more toll lanes, in accordance with some embodiments of the present disclosure;

FIG. 9 is a flow diagram showing a method for evaluating one or more detection tasks identified by one or more inference requests, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11A is a block diagram of an example generative LLM system suitable for use in implementing some embodiments of the present disclosure;

FIG. 11B is a block diagram of an example generative LLM that includes a transformer encoder-decoder suitable for use in implementing some embodiments of the present disclosure;

FIG. 11C is a block diagram of an example generative LLM that includes a decoder-only transformer architecture suitable for use in implementing some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

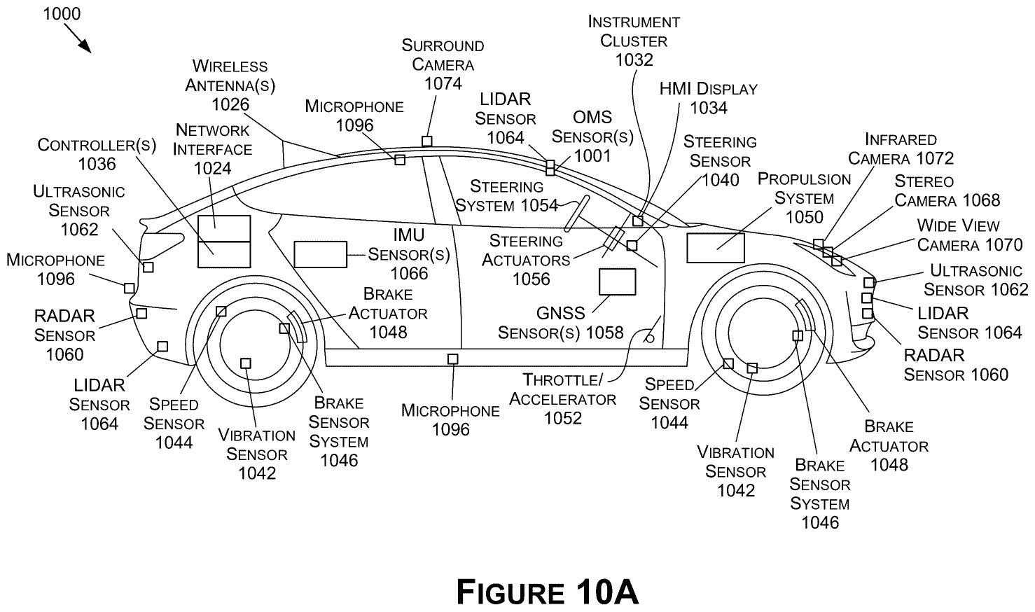

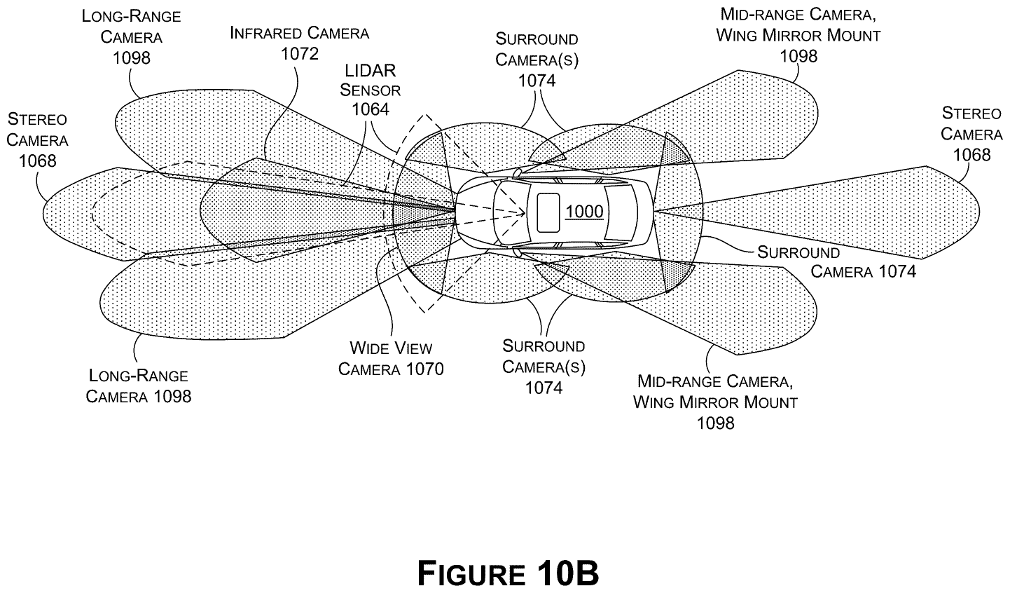

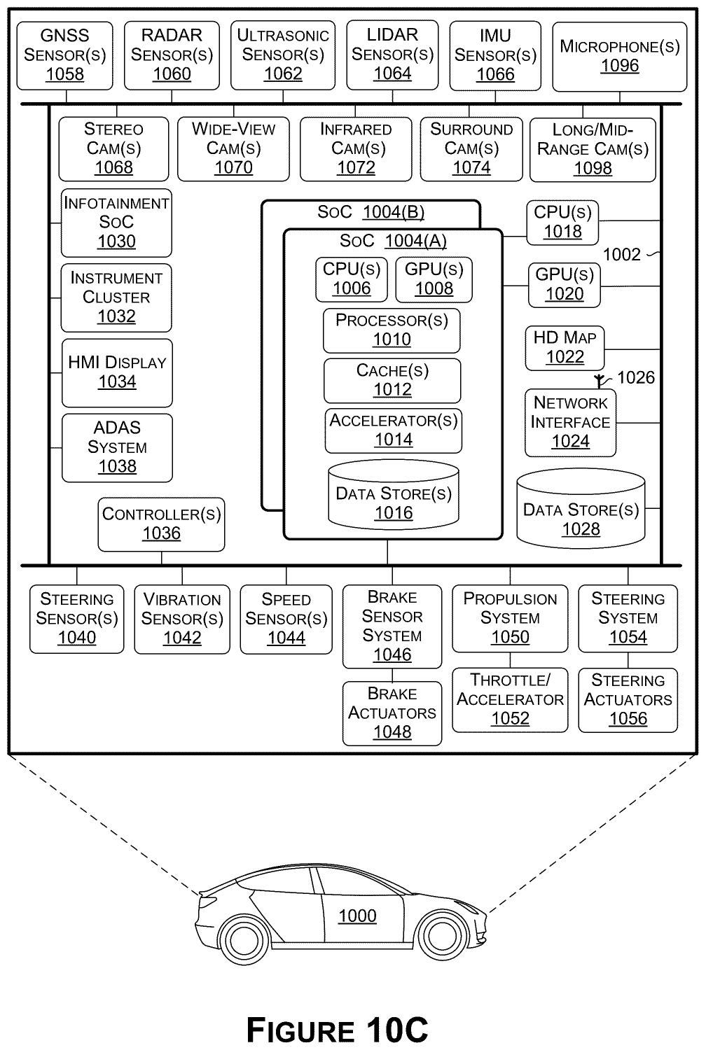

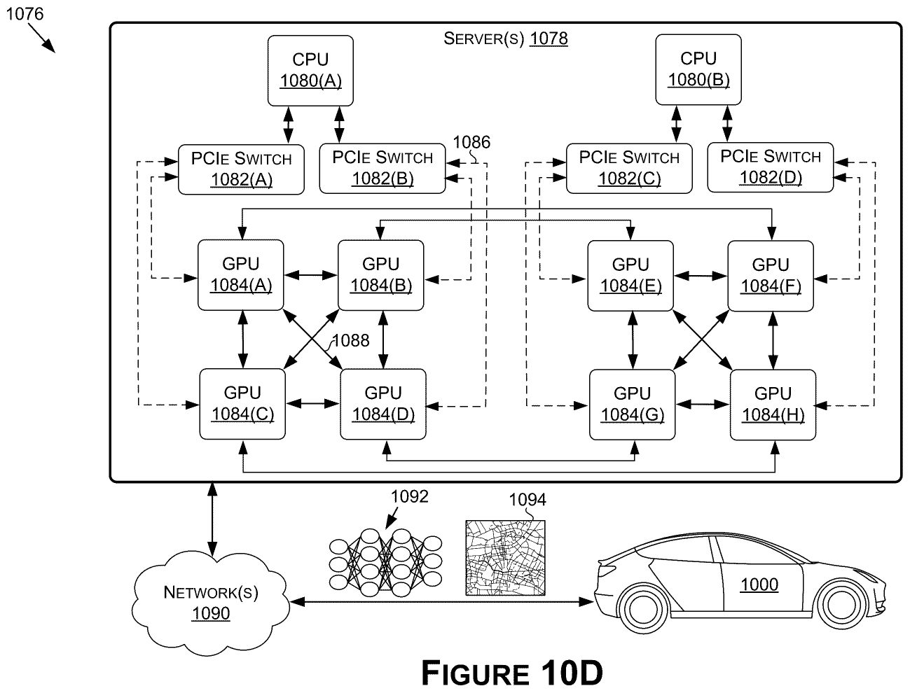

Systems and methods are disclosed related to driver monitoring, occupant monitoring, and/or environmental text perception using vision language models (VLMs). Although the present disclosure may be described with respect to an example autonomous or semi-autonomous vehicle, robot, or machine 1000 (alternatively referred to herein as “vehicle 1000” or “ego-machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to driver monitoring, occupant monitoring, and/or environmental text perception for autonomous or semi-autonomous vehicles, this is not intended to be limiting, and the systems and methods described herein may be used in augmented reality, virtual reality, mixed reality, robotics, security and surveillance, autonomous or semi-autonomous machine applications, and/or any other technology spaces where operator monitoring, occupant monitoring, and/or environmental text perception may be used.

In some embodiments, any number of DNNs in a detection pipeline for a given task may be replaced with a VLM, and the VLM may be prompted to determine whether a corresponding feature is present in an image or sampled frames from a video. The VLM may be trained and/or updated to perform one or more tasks (e.g., using autoregressive training and dense captions generated using a large language model (LLM)), the VLM may be prompted and/or constrained to generate a structured (e.g., binary, JavaScript Object Notation (JSON)) output, and the structured output may be used to control one or more downstream actions. As such, a single VLM may be used to support any number of detection tasks and corresponding prompts. The present techniques may be used for interior and/or exterior detection tasks, such as those performed by autonomous vehicles, semi-autonomous vehicles, robots, and/or other object or machine types.

Vision Language Models. Unlike traditional detection pipelines that perform narrow, specific functions in multiple stages and combine the resulting signals together using coded rules and state machines (e.g., if/else code), some embodiments replace any number of conventional detection stages with a VLM (e.g., that has been trained to perform driver monitoring, occupant monitoring, and/or environmental text perception functions in an end-to-end manner). VLMs generally have a more accurate world model than traditional detection pipelines, so replacing conventional (e.g., interior and/or exterior) detection functions with VLM(s) should improve the accuracy of corresponding tasks. To facilitate using the VLM(s) to control one or more downstream actions, the VLM(s) may be prompted using structured inputs, and a designated output format for a corresponding structured output may be enforced in any suitable manner (e.g., using prompt engineering, post-processing, training, multiple inferences, etc.). As such, the structured inputs and outputs for a given task may be considered key-value pairs representing detection states and corresponding signals, where the key of a particular key-value pair represents a structured input prompt and the VLM generates a corresponding value representing a structured output.

Dense Captions. In some embodiments, a VLM may be trained or updated (e.g., fine-tuned) using dense captions generated using an LLM. For example, some embodiments provide an approach for (e.g., video) monitoring of a driver, operator, or occupant using one or more VLMs. As such, training data for a driver, operator, or occupant monitoring task may be generated using videos of a driver, operator, or occupant. For example, one or more participants may be instructed to perform one or more actions (e.g., remove their seatbelt, adjust the rearview mirror, use both hands to text on the phone, etc.), and videos (e.g., 30 second clips) of the actions may be recorded. The videos and/or video frames may be associated with corresponding metadata (e.g., driver, operator, or occupant metadata representing driver, operator, or occupant attributes populated based on questionnaire responses, session attributes such as time of day or number of people in the vehicle or machine populated based on known conditions, scene metadata representing instructed actions, camera metadata indicating where the camera is positioned or how it is oriented, etc.), and an LLM may be prompted to generate a dense caption from the metadata. As such, the clips and corresponding dense captions may be used to train the VLM using auto-regressive training. For example, the VLM may be prompted to sequentially predict the dense caption based on a sequence of frames sampled from a corresponding training video to provide temporal context. Accordingly, the VLM may be trained or updated (e.g., fine-tuned) to perform any number of detection tasks (e.g., driver monitoring tasks, occupant monitoring tasks, environmental text perception or scene understanding tasks, etc.). As such, by taking advantage of the descriptive qualities of LLMs, training video metadata may be used to generate dense captions, which may be used to enhance the video understanding capabilities of the VLM(s).

DMS and OMS Tasks. Taking driver (or operator) and/or occupant monitoring as an example, any number of VLMs may be used to perform any number of driver and/or occupant monitoring tasks (e.g., driver drowsiness detection, driver distraction detection, driver or occupant out-of-position detection, driver or occupant identification, seatbelt usage detection, occupant presence detection, occupant classification, child presence detection, gesture recognition, detection of occlusions such as a camera blockage in which a driver or occupant is not visible in a camera frame due to an occlusion, and/or others). Taking driver distraction detection as an example, a VLM may be prompted to answer one or more queries (e.g., Is the driver distracted? Is the driver using a phone? Is the driver holding the steering wheel?) based on a set of sampled frames from a DMS camera, and the generated output may be used to control one or more downstream actions (e.g., issuing audible or visual alerts to refocus the driver, adjusting in-vehicle infotainment settings to minimize distractions, activating safety systems like adaptive cruise control or lane-keeping assistance, etc.). Depending on the applicable task and/or the implementation, the VLM may generate predictions based on an individual frame or a set of sampled frames.

Environmental Text Perception. In some embodiments, one or more VLMs may be used to perform environmental (e.g., text) perception. For example, an Advanced Driver Assistance System (ADAS) may identify candidate parking spaces, and a VLM may be used to evaluate parking signs and determine whether it is permissible and/or the cost to park in a candidate parking space. In another example, a VLM may be used to evaluate signs that designate restricted or toll lanes, determine whether it is permissible (and/or the cost) to merge into a restricted or toll lane, and/or determine when to merge out of a restricted or toll lane based on the cost.

In an example high-level workflow for localization and interpretation of world-text (e.g., text on traffic and/or parking signs) in an environment of an ego-machine, the state of the ego-machine (e.g., an operating state such as drive or park) may be used to trigger a corresponding VLM detection pipeline (or branch thereof). An applicable class or domain of the environment (e.g., urban vs. rural, parking lot vs. freeway vs. driveway, warehouse vs. factory, etc.) may be used to trigger identification (e.g., by one or more DNNs) of relevant text in the environment that may be applicable to the ego-machine and the applicable class or domain. For example, the relevant text may include any (e.g., all) costs or restrictions on ego-machine parking or operation represented by signage in the environment. As such, an image of the relevant text may be provided as an input to a VLM along with a prompt to determine whether a planned or candidate mode (e.g., drive or park) or operation (turn, parking) is allowed, and/or other relevant or conditional information that might apply (e.g., if the operation is allowed but restricted to certain hours of the day, certain speeds, requires payment, etc.).

For example, a parking evaluation pipeline may be initiated when an ego-machine enters a parking mode (e.g., based on a button press or voice command initiating parking mode, based on a signal from an ADAS indicating parking has been initiated). An applicable parking domain (e.g., urban, parking garage) may be detected using a mapping application programming interface (API) or using a VLM to infer the domain based on a video stream. Depending on the detected parking domain, frames from corresponding (e.g., front-facing, repeater, side pillar) camera(s) may be evaluated for corresponding parking signs (e.g., using a sign recognition DNN, prompting a VLM to determine whether there is text present and if so a corresponding bounding box or other shape). When a parking sign is detected, its legibility may be verified (e.g., based on the coverage of a detected region of interest (RoI), by prompting a VLM to determine whether the sign is legible enough to understand), and, if verified, the (e.g., cropped image of the) sign may be cached. As such, the (e.g., most recently) cached image of the sign may be provided as input to a VLM with a prompt to determine whether it is permissible to park in the candidate parking space (and if so, the cost) given inputs such as the current time, day of the week, special days (e.g., holidays or special event days), location context (e.g., presence in a region of a map, such as a school zone that imposes restrictions during certain hours, a residential zone that place restrictions on non-residents, a business district that imposes restrictions during business hours; proximity to intersections; etc.), any preconfigured (e.g., geo-tagged) parking permits, and/or user input designating a desired duration of parking time. In some embodiments, cached images of multiple signs (e.g., detected from a common segment or region of a map such as the same city block or geo-fenced region) may be provided as input to a VLM with a prompt to determine whether there is a conflict between signs, which sign is applicable, and/or whether parking in the candidate parking space is permitted based on the signs. As such, the VLM may be used to resolve various types of ambiguities, such as overlapping days or times (e.g., one sign that says “No parking Monday 8 AM-10 AM” for street cleaning and another that says “2-hour parking Monday-Friday, 9 AM-6 PM”), conflicts between temporary and permanent signs (e.g., special event conflicts), and others. The generated response may be provided to the ADAS to confirm or invalidate the candidate parking space, and a representation of the results may be provided to the driver (e.g., valid parking spaces may be visualized with green overlays, invalid parking spaces may be visualized with red overlays, predicted costs may be visually represented or audibly output using synthesized speech, etc.).

Additionally or alternatively, a VLM may be used to evaluate signs that designate restricted or toll lanes. For example, when driving outside of a restricted or toll lane (e.g., an express or high-occupancy toll (HOT) lane), a VLM may be used to evaluate a toll sign indicating the toll for an upcoming road segment and determine whether to enter the restricted or toll lane based on the upcoming toll, a designated maximum toll per journey, and the current tolls accrued on the journey. When driving in a restricted or toll lane, a VLM may be used to evaluate a toll sign indicating the toll for an upcoming road segment and determine whether to exit the restricted or toll lane based on the upcoming toll, a designated maximum toll per journey, and the current tolls accrued on the journey.

In an example high-level workflow for recognizing and understanding text corresponding to a highway tolling and payment system, a highway toll sign evaluation pipeline may be initiated when an ego-machine enters a highway driving mode (e.g., based on a signal from an ADAS indicating highway driving has been initiated), periodically (e.g., to check for bridge or tunnel toll signs), and/or based on entering or approaching a geo-tagged location. Frames from one or more (e.g., front-facing) camera(s) may be evaluated for toll signs (e.g., using a sign recognition DNN, prompting a VLM to determine whether there is text present and if so a corresponding bounding box or other bounding volume). When a toll sign is detected, its legibility may be verified (e.g., based on the coverage of a detected RoI, by prompting a VLM to determine whether the sign is legible enough to understand, or to infer an identification of the sign and corresponding information), and, if verified, the (e.g., cropped image of the) sign may be cached, and a list of upcoming exits (e.g., between the current location and a planned exit on a mapping route) may be generated. As such, the (e.g., most recently) cached image of the sign may be provided as input to a VLM with a prompt to determine whether it is permissible to drive in the restricted or toll lane (and if so, the cost to drive in the restricted or toll lane through the next exit) given inputs such as a designated maximum toll per journey, the current tolls accrued on the journey, the list of upcoming exits, and the planned exit (if applicable). In some implementations when the highway tolling and payment system depends on the number of occupants in the vehicle, an on-board OMS and/or a VLM may be used to determine the number of machine occupants or operators (e.g., triggered when the ego-machine is turned on), and the number of occupants may be included in the prompt. The generated response (e.g., yes or no) may be provided to the ADAS to trigger an initiation of a merge left or right or a determination to stay in the current lane. If the restricted or toll lane is taken, the cost of the tolls accrued on the journey (e.g., output by the VLM) may be cached for a subsequent prompt.

Inference Scheduler and Prioritization. In some embodiments, the same VLM may be used to support different types of detection tasks (e.g., one foundational VLM supporting some or all detection tasks performed by an ego-machine, one VLM for interior sensing tasks and one for exterior sensing tasks, etc.), and an inference scheduler may be used to serve or handle inference requests for the VLM(s) to perform the different tasks. Generally, inference requests for different tasks may be triggered by some event (e.g., prompting the VLM to perform hands-on-wheel detection when the ego-machine is engaged in level 1 or 2 automation, prompting the VLM to perform child presence detection when a driver and/or occupant exits the vehicle and shuts the door) and/or may be submitted periodically (e.g., prompting the VLM to determine whether the driver is distracted every few seconds). Taking an example detection task that operates over some temporal context window (e.g., drowsiness or distraction detection), some designated number of frames may be encoded, queued, and periodically sampled from a (e.g., sliding) window and submitted with a prompt as part of an inference request to a VLM. Depending on the task and/or the implementation, periodic inference requests for a VLM may be submitted to the scheduler when a previous request is completed or at some fixed rate (e.g., 30 or 60 frames per second (fps)). Inference requests from different detection applications may be submitted at various times and/or rates. As such, the scheduler may queue, manage, and distribute inference requests from different detection applications to the VLM(s).

In some embodiments, the scheduler prioritizes inference requests based on a safety assessment. For example, the scheduler may prioritize inference requests from some detection application(s) over inference requests from other detection application(s) (e.g., prioritizing inference requests to perform ADAS tasks such as pedestrian detection, bicycle detection, or trajectory planning over requests to perform driver or occupant monitoring tasks, prioritizing exterior sensing tasks over interior sensing tasks, etc.). Generally, depending on the implementation and/or the scenario, there may be multiple in-flight (e.g., queued) inference requests at any given time. For example, drowsiness and/or distraction detection requests may be submitted periodically (e.g., every 2 seconds), sign evaluation requests may be submitted periodically (e.g., every 5-10 seconds), requests to evaluate candidate trajectories may be submitted on demand (e.g., multiple times per second), and/or other types of requests for interior or exterior sensing tasks may be submitted (e.g., lane detection, object detection, sign recognition, context-aware question answering of contextual inquiries to answer user questions about a scene, requests to determine whether a designated object has been left behind, suspicious activity monitoring such as intrusion detection (e.g., sentry mode) requests to detect whether a nearby person has some kind of malicious intent, etc.). As such, inference requests from tasks may be assigned a priority (e.g., hard-coded, by a VLM, etc.) based on safety such that inference requests from tasks deemed more important to safety may be served before inference requests from lower priority tasks.

The present techniques result in a variety of benefits. Generally, replacing a conventional, multi-stage, detection pipeline (e.g., drowsiness detection, distraction detection, child presence detection) with a VLM results in simplified architecture, reduces the amount and types of training data which need to be collected/generated, reduces the number of steps and modules otherwise required for the applicable (e.g., driver monitoring, occupant monitoring, environmental sensing) task, and reduces latency and the consumption of available time and compute bandwidth, which may therefore be reallocated for other relevant or critical tasks on-board the ego-machine. Even replacing a single conventional DNN with a VLM often results in a more holistic evaluation and often results in an increase in detection accuracy.

Furthermore, some detection tasks like drowsiness detection are inherently challenging. Conventional drowsiness detection often relies on blink features, which vary to such an extent across the population that it becomes hard to predict accurately. As a result, conventional drowsiness detection pipelines tend to encode and evaluate blink features (e.g., velocity, amplitude) in a longer context window using a one-dimensional convolutional neural network. Using a VLM to perform drowsiness detection on two-dimensional frames sampled over time dramatically expands the available context. As such, the present techniques may be used to directly evaluate a video for tasks like this and others, improving the detection accuracy over existing techniques.

As such, the present techniques may be used to increase the accuracy of various driver monitoring, occupant monitoring, and/or environmental text perception tasks using VLMs.

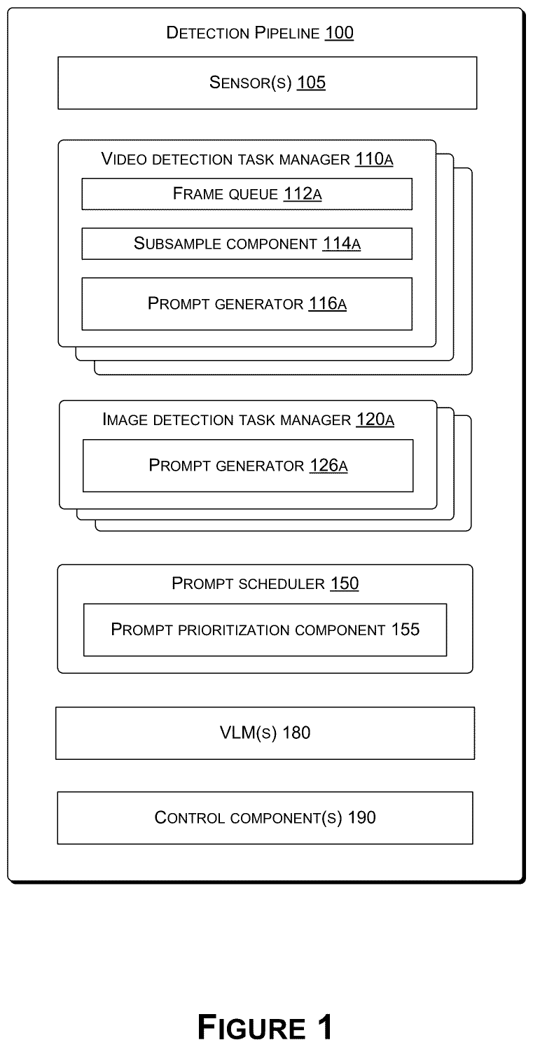

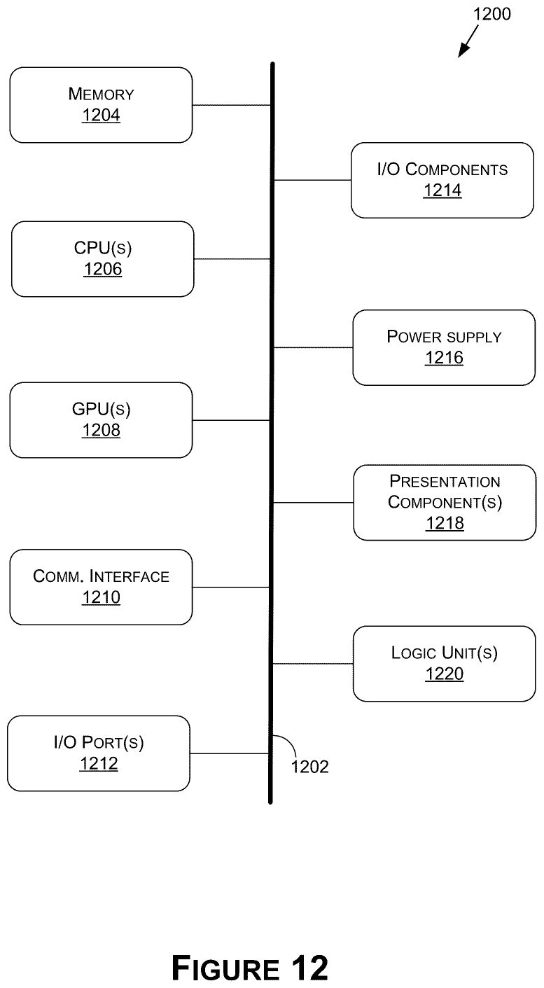

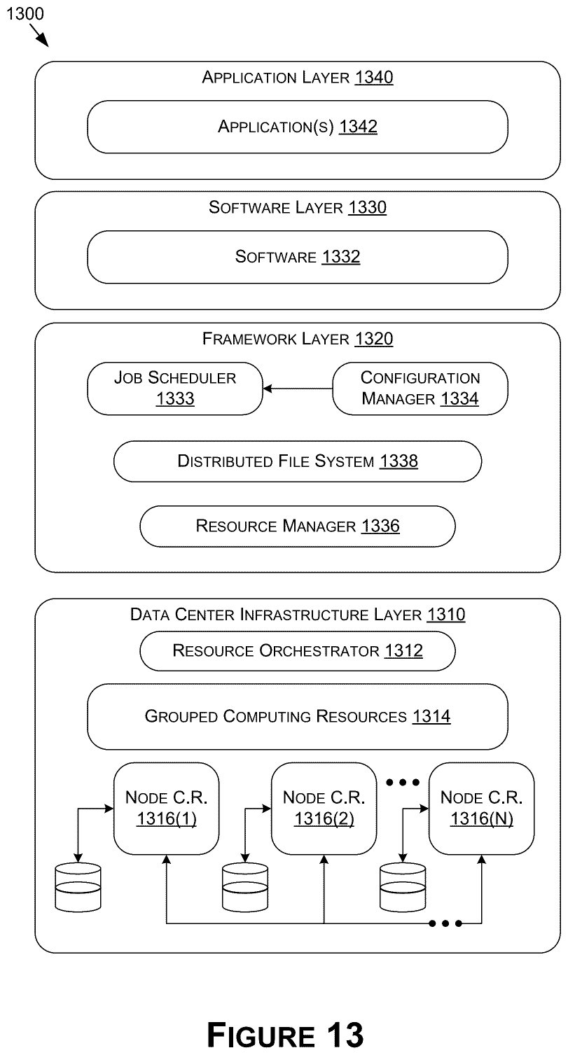

With reference to FIG. 1, FIG. 1 is an example detection pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 1000 of FIGS. 10A-10D, example computing device 1200 of FIG. 12, and/or example data center 1300 of FIG. 13.

As a high level overview, the detection pipeline 100 may be incorporated into an ego-machine, such as the autonomous vehicle 1000 of FIGS. 10A-10D. In the embodiment illustrated in FIG. 1, the detection pipeline 100 includes sensor(s) 105, video detection task manager(s) 110a-n, image detection task manager(s) 120a-n, a prompt scheduler 150, VLM(s) 180, and control component(s) 190. Generally, any given implementation may include any number of video detection task manager(s) 10a-n for corresponding video detection tasks, any number of image detection task manager(s) 120a-n for corresponding image detection tasks, and/or any number of VLM(s) 180. Although some embodiments are described with a single VLM serving multiple detection tasks via the prompt scheduler 150, this is meant simply as an example configuration. For example, some embodiments may implement a single video or image detection task using a single VLM (or multiple VLMs), multiple video or image detection tasks using a single VLM (or multiple VLMs), or otherwise, with or without the prompt scheduler 150. Variations may be implemented within the scope of the present disclosure.

At a high level, and taking the video detection task manager 110a and/or the image detection task manager 120a as an example, the sensor(s) 105 may be used to generate sensor data representing an interior or exterior space, the video detection task manager 10a and/or image detection task manager 120a may prompt the VLM(s) 180 (e.g., via the prompt scheduler 150) to perform a corresponding detection task by evaluating corresponding sensor data, and the VLM(s) 180 may return a response indicating the result(s) of the requested detection task. As such, the video detection task manager 10a and/or image detection task manager 120a may provide a corresponding control component(s) 190 with a representation of the result(s), and the control component(s) 190 may take some responsive action. Generally, the sensor(s) 105, the control component(s) 190, and/or the responsive action may depend on the detection task and/or the implementation.

The sensor(s) 105 may include any number and/or any type of sensor, such as, without limitation, one or more cameras, LiDAR sensors, RADAR sensors, and/or other sensor types such as those described below with respect to the autonomous vehicle 1000 of FIGS. 10A-10D. Taking a perception task such as a DMS or OMS task an example, the sensor(s) 105 may be positioned to perceive one or more humans or other subjects (e.g., objects left behind) in an interior or exterior space or other environment in which one or more humans or other subjects may be present (e.g., seating, footwells, etc.), and may be used to generate frames of sensor data (e.g., images) at any suitable frame rate. In some embodiments, the sensor(s) 105 may include one or more sensors of an ego-machine (e.g., an OMS or DMS camera such as the OMS sensor(s) 1001 of the vehicle 1000, one or more exterior cameras such as the stereo camera(s) 1068, wide-view camera(s) 1070 (e.g., fisheye cameras), infrared camera(s) 1072, surround camera(s) 1074, and/or long-range and/or mid-range camera(s) 1098 of the vehicle 1000, etc.), and the sensor(s) 105 may be used to generate frames of sensor data that represent an environment being monitored (e.g., an environment outside the ego-machine, an interior space, an operator or occupant of an ego-machine, some other monitored subject).

In some embodiments, the sensor(s) 105 comprise one more sensors (e.g., cameras) of a monitoring system such as an OMS. In an example in-cabin or cockpit monitoring system such as a vehicle OMS, one or more optical sensors may be positioned to perceive a scene within the cabin, cockpit, or other interior space. An OMS may comprise a DMS, a system that monitors non-driver occupants, or a system that monitors driver (operator) occupant(s) and/or non-driver occupant(s). OMSs often rely on perception from multiple optical sensors (e.g., RGB sensors, infrared IR sensors, depth sensors, cameras, etc.) positioned at various locations throughout a vehicle interior. Vehicle manufacturers tend to vary the number of OMS cameras from model to model and depending on the trim level. Base models usually have one camera facing the driver (e.g., positioned within a steering column, vehicle pillar, or infotainment console). Higher trim levels may include any number of additional cameras (e.g., one in the steering column facing the driver, one in the rear review mirror facing the driver or the cabin, one in a vehicle pillar facing a particular row of seating, one above a row of headrests facing forward for child detection, etc.). Generally, occupant and/or driver monitoring systems may include any number of cameras (e.g., 4 DMS cameras and 16 OMS cameras) positioned throughout a vehicle interior. These are just a few examples of possible sensor layouts, and other sensor layouts within any suitable interior scene (e.g., supermarket aisle, hospital operating room, retail store, office space, manufacturing facility, etc.) or exterior scene (e.g., city street, construction site, agricultural field, public transportation hub, urban environment, etc.) may be implemented within the scope of the present disclosure.

Any or all of the sensor(s) 105 may be used to generate a frame of sensor data (e.g., an image generated using each of one or more OMS and/or exterior cameras) for each time slice (e.g., at any suitable frame rate, which may depend on the sensor, detection task, implementation, and/or other factors), the video detection task manager 110a and/or image detection task manager 120a may use the frame of sensor data from corresponding sensor(s) 105 to prompt or otherwise issue inference requests for the VLM(s) 180 at any suitable frame rate (whether or not at the same rate the sensor data was generated). In some implementations, different detection tasks may operate at different frame rates.

Depending on the implementation, the video detection task manager 110a and/or image detection task manager 120a may manage any suitable detection task, for example, by determining when to perform an inference, determining which sensor data to evaluate, generating (e.g., by a corresponding prompt generator 116a or 126a) a representation of a prompt that uses structured input(s) to instruct the VLM(s) 180 to perform a detection task evaluating the sensor data, processing one or more responses from the VLM(s) 180, and/or providing a representation of the response(s) to corresponding control component(s) 190 or otherwise instructing the corresponding control component(s) 190 to take a corresponding action. For example, the prompt generator 116a or the prompt generator 126a may use any known prompt engineering technique (e.g., using system prompts, role-based prompts, instruction prompts, question prompts, multi-turn prompts, etc.) to provide designated questions and/or instructions to the VLM(s) 180 corresponding to the applicable detection task.

Example detection tasks (and corresponding sample questions) include DMS tasks such as driver distraction detection (Is the driver distracted? Is the driver looking on-road or offroad? Is the driver using a phone?), driver drowsiness detection (Is the driver falling asleep or showing signs of drowsiness?), driver out-of-position detection (Is the driver seated correctly? Are the driver's limbs in a safe position?Is the driver leaning or slouched?), hands-on-wheel detection (Are both the driver's hands on the steering wheel? Is at least one hand on the steering wheel?), and driver presence detection or identification (Is there a driver in the vehicle? Is the detected occupant the authorized driver?); OMS tasks such as child or occupant presence detection or identification (Is there an occupant in the vehicle? Is there a child in the vehicle? Is there an unattended child in the vehicle?), occupant classification (Is there an occupant in the seat? Is the occupant a child or an adult? Is the occupant using a child safety seat?), rear-facing child seat monitoring (e.g., Is the baby properly secured in the car seat? Is the baby awake? Is the baby still sleeping?), occupant out-of-position detection (Is the occupant seated correctly? Are the occupant's limbs in a safe position?), distress detection (Is the driver experiencing a medical emergency? Is the driver exhibiting signs of emotional distress?), seatbelt usage detection (Is the seatbelt fastened? Is the seatbelt properly positioned? Are all occupants using their seatbelts?), and gesture recognition (Is an occupant making a recognizable gesture? What gesture is the occupant making? Is the gesture intended to interact with the vehicle's system?); and exterior or other environmental sensing tasks such as sign detection or evaluation (Is there a sign present? What type of sign has been detected? Is the detected sign visible and clear?), parking space detection or evaluation (Is there an available parking space? Is the parking space large enough to accommodate the vehicle?), trajectory evaluation (Is the current trajectory safe? Is the trajectory in compliance with traffic rules?), lane detection (Are the lane markings visible? Is the vehicle centered within its lane or drifting towards the edges? Is the vehicle departing from its lane?), context-aware question answering of contextual inquiries to answer user questions about a scene (What is the big building on the left? What did that sign say?), object-left-behind detection (Is there an object left behind in the vehicle? Where is the object located within the vehicle? Is the object a [designated type of object]?), suspicious activity monitoring (Is there any movement around the vehicle? Is someone approaching the vehicle? Is there any unusual behavior detected near the vehicle? Is there an attempt to open the doors or trunk? Are there any unauthorized people around the vehicle?), and/or others. Some example detection tasks are described in more detail below.

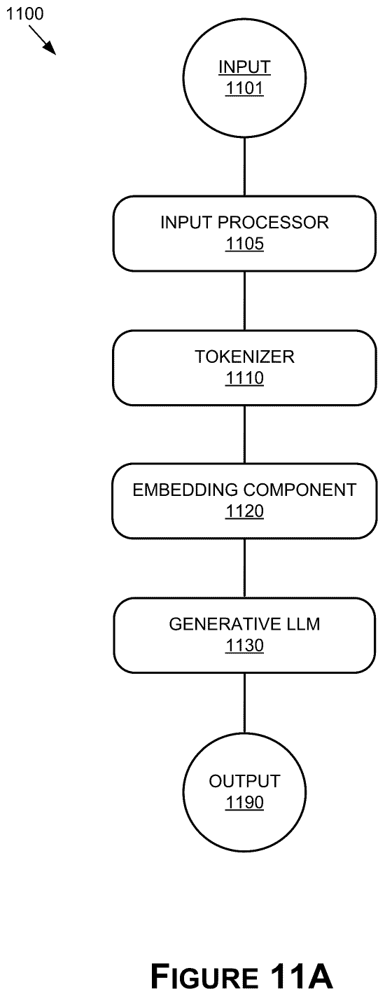

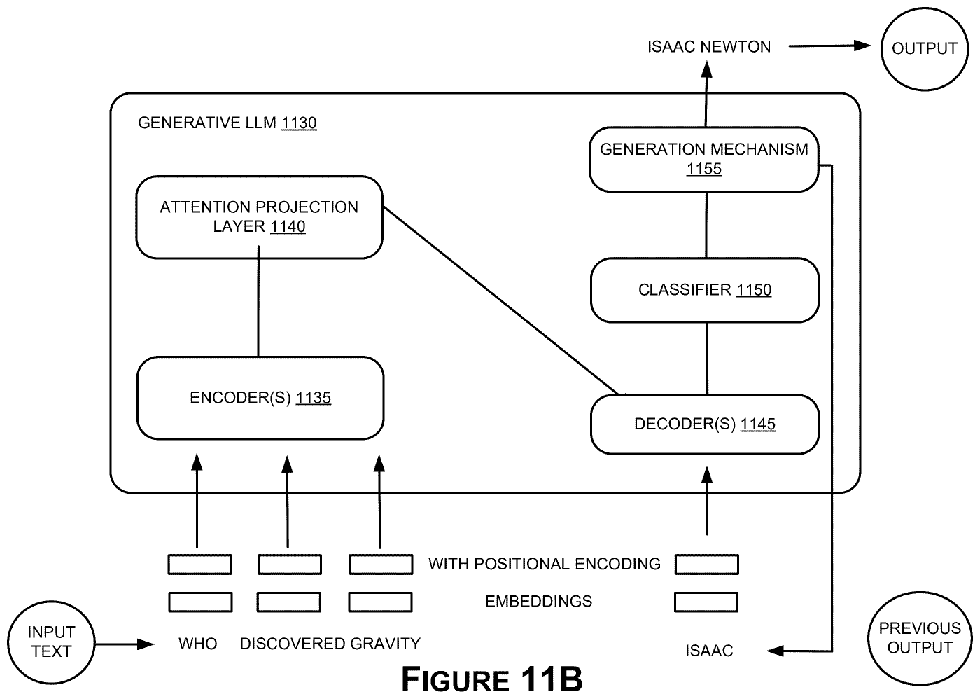

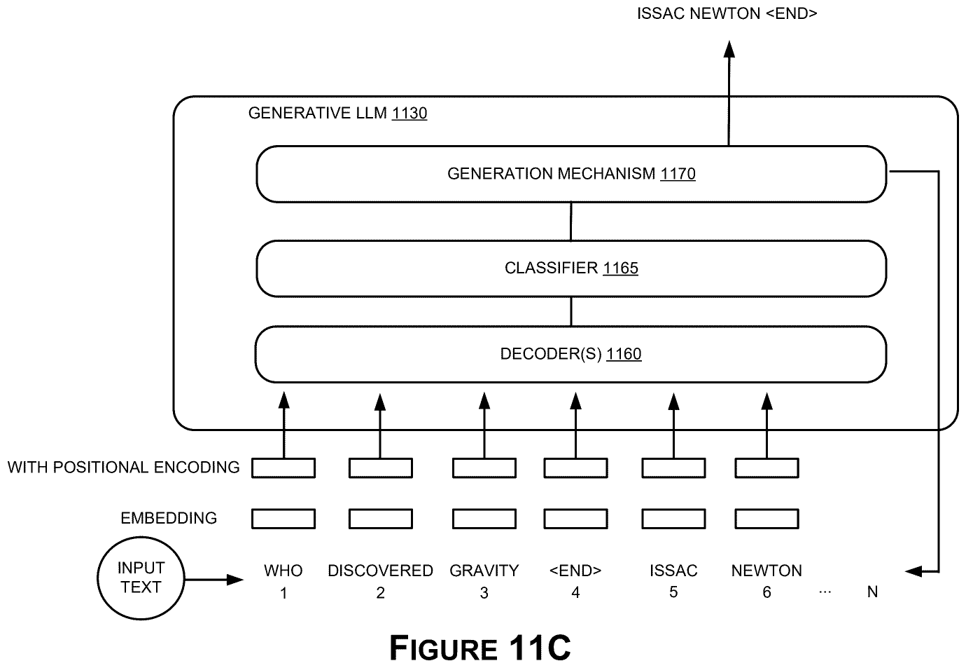

Generally, the VLM(s) 180 may use any known VLM architecture capable of processing text and image data. An example VLM (e.g., which may correspond to the example generative LLM system 1100 of FIG. 11A) includes a vision encoder, a projector, and an LLM such as the generative LLM 1130 of FIGS. 11A, 11B, or 11C. Depending on the implementation, the VLM(s) 180 may include a pre-trained or foundational LLM, such as NVIDIA's Megatron-Turing Natural Language Generation (MT-NLG) or Megatron-LM; OpenAI's GPT series; Google's T5 or Pathways Language Model (PaLM); Meta's BlenderBot or Large Language Model Meta AI (LLaMA) series, Anthropic's Claude series, or others.

Generally, the VLM(s) 180 may perform some detection tasks by evaluating a multimodal prompt comprising a textual prompt that is applied to a textual input channel and an associated image data (e.g., an image generated using a camera, a projection image generated by projecting sensor data such as RADAR or LiDAR data into a 2D view) that is applied to a visual input channel (e.g., comprising a vision encoder). However, some detection tasks such as driver drowsiness or distraction detection may benefit from temporal context. As such, in some embodiments, the VLM(s) 180 include one or more video LLMs (e.g., Language Instructed Temporal-Localization Assistant (LITA)) capable of evaluating a textual prompt and associated input video data (e.g., a representation of multiple sampled frames of image data from a video). For example, the video detection task manager 110a may include a frame queue 112a and may store frames of image data from a sliding temporal window (or may use a corresponding vision encoder to generate and store visual embeddings for the frames) in the frame queue 112a, the subsampling component 114a may use any known technique to sample the frames and generate a representation of the sampled frames (e.g., sampling frames or slow tokens over a longer temporal window to represent spatial information and/or sampling frames or fast tokens over a shorter temporal window to represent temporal information), and the prompt generator 116a may apply a prompt comprising a textual prompt and the representation of the sampled frames to respective textual and visual input channels of a video LLM (or otherwise identify the prompt for the video LLM). These are meant simply as examples, and other VLM architectures may be implemented within the scope of the present disclosure.

In some embodiments, the video detection task manager(s) 110a-n may generate a prompt(s) for video LLM(s) of the VLM(s) 180, and the image detection task manager(s) 120a-n may generate a prompt(s) for VLM(s) 180 that are designed to process and understand an individual image input (including concatenated images), but this need not be the case. For example, although video LLMs are designed to handle sequences of frames and temporal information, they may additionally or alternatively be used to process and analyze individual images. As such, in some embodiments, the video detection task manager(s) 110a-n and/or the image detection task manager(s) 120a-n may prompt video LLM(s) of the VLM(s) 180.

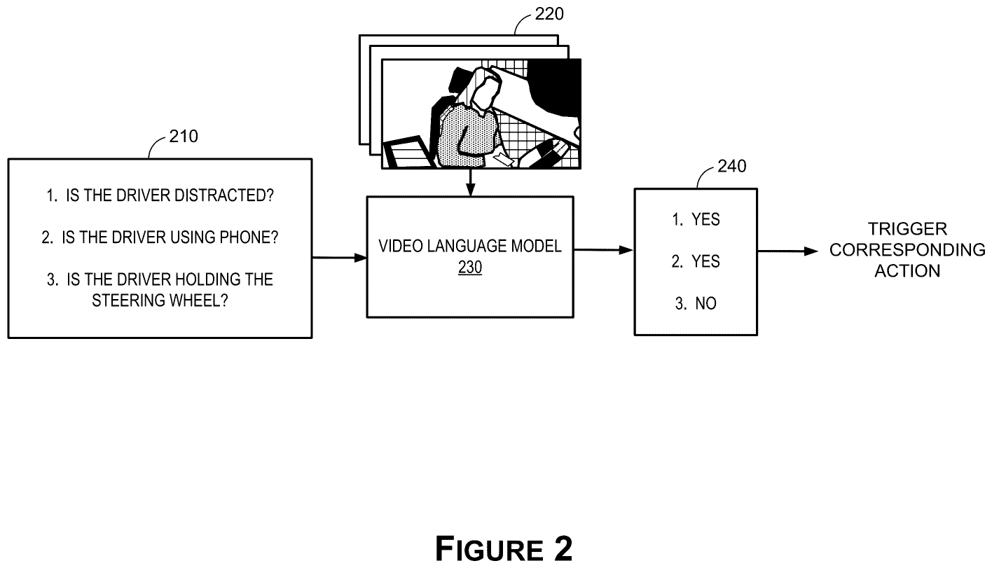

Continuing with a high level overview of FIG. 1, in some embodiments, the VLM(s) 180 may be (e.g., iteratively) prompted by a corresponding video detection task manager 110a and/or image detection task manager 120a (e.g., via the prompt scheduler 150) using structured inputs, and a designated output format for a corresponding structured output may be enforced using any known technique (e.g., using prompt engineering, post-processing, training, multiple inferences, etc.). Taking the example driver distraction detection technique illustrated in FIG. 2 as an example, the video detection task manager 110a may generate a multimodal prompt comprising a textual representation of one or more queries 210 (e.g., Is the driver distracted? Is the driver using a phone? Is the driver holding the steering wheel?) and some representation or identification of sampled frames 220 from a DMS camera, and may issue the prompt for a video language model 230 to evaluate. The video language model 230 may be constrained to generate a structured response 240 (e.g., binary, JSON) using any known technique, so the video language model 230 may evaluate the sampled frames 220 and generate and return the structured response 240 to the video detection task manager 110a. As such, the video detection task manager 110a may provide the structured response 240 (or may decode and provide a representation of the structured response 240) to corresponding control component(s) 190 to perform one or more responsive actions (e.g., issuing audible or visual alerts to refocus the driver, adjusting in-vehicle infotainment settings to minimize distractions, activating safety systems like adaptive cruise control or lane-keeping assistance, etc.).

Generally, the applicable control component(s) 190 may depend on the detection task and/or the implementation. In some embodiments, the control component(s) 190 are part of an ADAS such as the ADAS system 1038 of FIG. 10C, and the control component(s) 190 may coordinate and/or manage one or more functions within the ADAS. Generally, the ADAS may use any known technique to assess the vehicle's surroundings, identify potential risks or hazards, and/or implement autonomous driving features such as adaptive cruise control, automatic emergency braking, lane-keeping assistance, and/or collision avoidance systems, to name a few examples. Taking DMS tasks such as driver drowsiness or distraction detection as an example, if the VLM(s) 180 detect the driver is not attentive or in a drive-ready position, the control component(s) 190 may trigger one or more alerts (auditory, visual, or haptic) to regain the driver's attention, adjust one or more driver assistance features such as adaptive cruise control (e.g., increase the following distance or reduce the vehicle's speed) or lane keeping assistance (e.g., be more proactive in correcting lane deviations), trigger the ADAS to execute one or more safety interventions (e.g., automatic braking, emergency steering, transition to autonomous driving mode), etc.

Taking some example OMS tasks, if the VLM(s) 180 detect the presence of an occupant, the control component(s) 190 may enable safety features such as airbags or seatbelt reminders, or activate systems such as climate control and/or infotainment. If the VLM(s) 180 detect a known occupant, the control component(s) 190 may adjust settings such as seat position or temperature to saved preferences. If the VLM(s) 180 classify an occupant as an adult or a child, the control component(s) 190 may adjust airbag deployment or child lock settings. If the VLM(s) 180 detect distress, the control component(s) 190 may trigger some emergency response (e.g., contacting emergency services, displaying or announcing emergency instructions). If the VLM(s) 180 detect a seat belt is not being worn, the control component(s) 190 may prevent the vehicle from starting, limit its speed, or issue a visual or auditory reminder to fasten the seat belt. If the VLM(s) 180 recognize a particular gesture, the control component(s) 190 may execute or trigger a corresponding function (e.g., adjusting volume, changing temperature, opening windows). If the VLM(s) 180 detect that a baby in a car seat woke up, the control component(s) 190 may trigger a corresponding visual or audible notification for the operator or other occupant, prompt for or accept input triggering soothing music or white noise, and/or otherwise.

Taking a parking sign and/or parking space evaluation as an example, if the VLM(s) 180 determine(s) it is permissible to park in a candidate parking space, the control component(s) 190 may initiate parking in the candidate space or provide some real-time feedback indicating the determination (e.g., emphasizing permissible parking spaces on a map or visualization of the surrounding environment, triggering a visual or audible notification). Conversely, if the VLM(s) 180 determine it is not permissible to park in a candidate parking space, the control component(s) 190 may negate the candidate parking space or provide some real-time feedback indicating the determination.

Taking evaluation of a toll or restricted lane sign as an example, if the VLM(s) 180 determine it is permissible to merge into a restricted or toll lane (e.g., within a designated budget), the control component(s) 190 may initiate the merge. Conversely, if the VLM(s) 180 determine it is not permissible to merge into a restricted or toll lane (e.g., within a specified budget), the control component(s) 190 may determine not to initiate the merge.

Taking some other possible detection tasks as examples, if the VLM(s) 180 determine a candidate trajectory is safe, the control component(s) 190 may trigger the vehicle to take the candidate trajectory (and vice versa). If the VLM(s) 180 detect updated lane boundaries in the lane the vehicle is currently navigating, the control component(s) 190 may trigger one or more controls that maintain the position of the vehicle within the lane (e.g., lane keeping), alert the driver that the vehicle is starting to drift out of its lane without signaling, plan for or execute a lane change or an upcoming turn, etc. If the VLM(s) 180 answer a contextual inquiry about the environment an ego-machine is navigating, the control component(s) 190 may provide a visual or audible representation of the answer. If the VLM(s) 180 detect a (e.g., previously designated) object left behind (e.g., in response to detecting one or more of the occupants exiting the vehicle), the control component(s) 190 may issue an audible alert, trigger a notification via a mobile app, or otherwise issue a notification. If the VLM(s) 180 detect suspicious activity such as an attempted intrusion, the control component(s) 190 may alert the owner or occupant(s), notify authorities, and/or activate security measures such as locking doors or recording video footage. The foregoing detection tasks and corresponding controls are meant simply as non-limiting examples, and variations and other detection tasks may be implemented within the scope of the present disclosure.

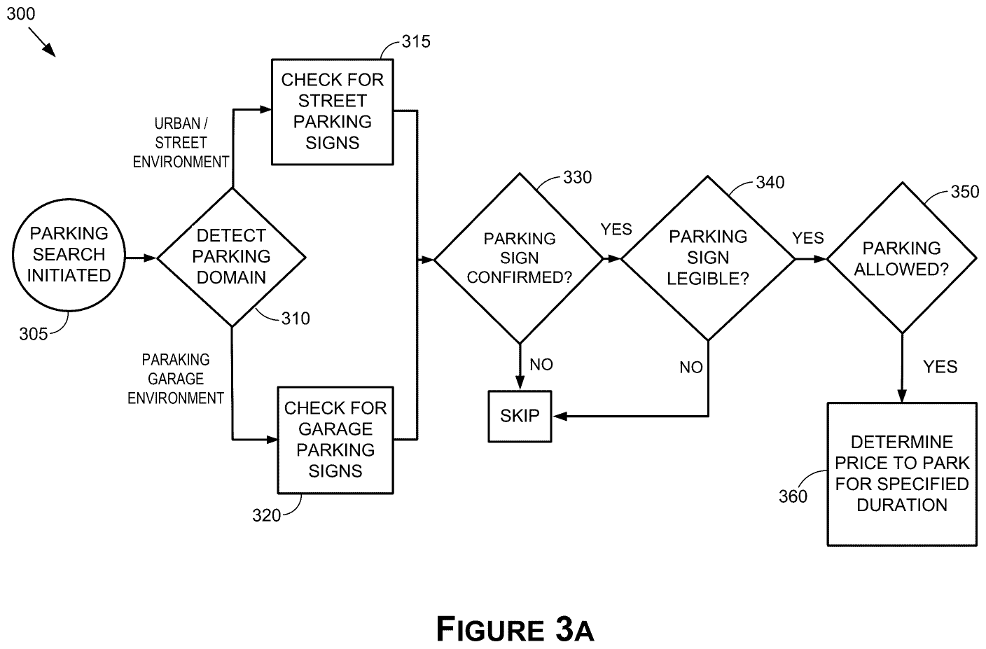

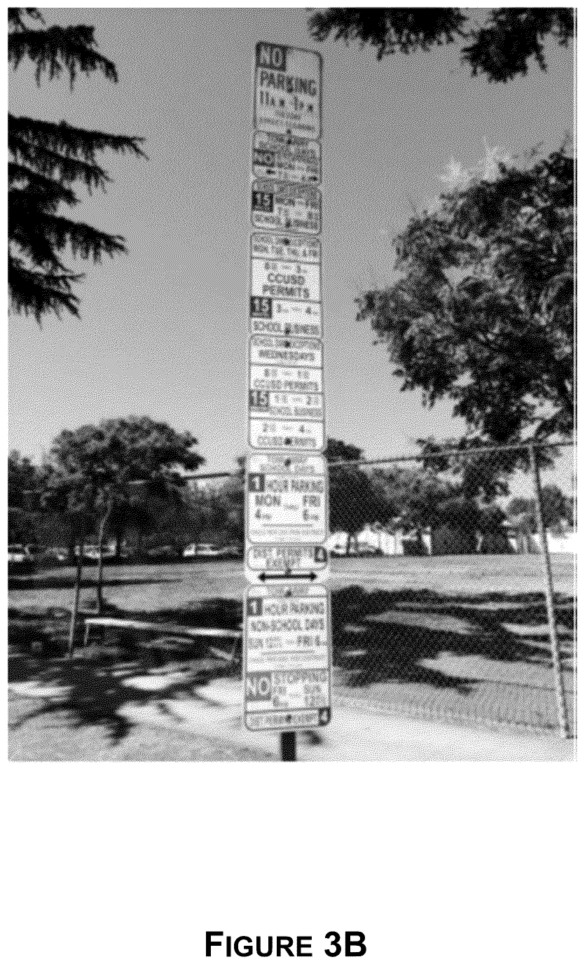

In some embodiments, the VLM(s) 180 may be used to perform environmental (e.g., text) perception, for example, by evaluating signs represented in image data (e.g., one or more frames representing a single time slice or sampled frames from a video representing multiple time slices). In an example implementation involving parking sign evaluation, the control component(s) 190 (e.g., an ADAS) may identify candidate parking spaces using any known technique, and the VLM(s) 180 may be used to evaluate image data representing detected parking sign(s) and determine whether it is permissible and/or the cost to park in a candidate parking space. FIG. 3A is a data flow diagram illustrating an example parking sign evaluation pipeline 300 for evaluating a parking sign such as the one illustrated in FIG. 3B. The parking sign evaluation pipeline 300 may be implemented by the video detection task manager 110a, the image detection task manager 120a, and/or the VLM(s) 180 of FIG. 1.

Taking an example implementation that evaluates images of parking signs, at block 305, the image detection task manager 120a may receive a signal indicating a parking search or search-for-parking mode has been initiated. For example, the ego-machine may include a button, control panel, (e.g., infotainment) touchscreen or other display, dashboard, or other device that accepts a press or touch input, a voice interface that accepts a voice command, or some other interface that accepts some type of input command initiating a search-for-parking mode. Additionally or alternatively, an ADAS such as the ADAS system 1038 of FIG. 10C may use any known technique to determine that the ego-machine is looking for parking (e.g., based on slow driving, frequent stops, or repeated circling in a region associated with parking; inferring parking search behavior using a machine learning algorithm; etc.). As such, a signal indicating that a search-for-parking mode has been detected or initiated may be provided to the image detection task manager 120a, and in response, the image detection task manager 120a may initiate the parking sign evaluation pipeline 300.

At block 310, the image detection task manager 120a may detect (or trigger detection of) the applicable parking domain. In some embodiments, the image detection task manager 120a may detect the applicable parking domain (e.g., urban, parking garage or lot) using a mapping API. For example, streets, parking facilities, and/or known parking areas may be represented in a database using corresponding coordinates, boundaries, regions, or other features. The image detection task manager 120a may determine the ego-machine's location using any known technique (e.g., a Global Navigation Satellite System (GNSS) or Global Positioning System (GPS)) and may provide the location via a mapping API to a location-based service that cross-references a database to determine and return the applicable parking domain. In some embodiments, the video detection task manager 110a may generate and transmit a representation of a prompt for the VLM(s) 180 to infer the domain based on sampled frames from a video stream from one or more (e.g., front-facing, repeater, side pillar) exterior cameras. Any known technique may be used to constrain the VLM(s) 180 to a structured output or otherwise extract the inferred domain from the generated response.

In some embodiments, depending on the detected parking domain, different techniques may be used to detect parking signs. For example, at block 315, the image detection task manager 120a may access frames of image data from one or more (e.g., front-facing, repeater, side pillar) exterior cameras, and may apply the frame(s) of image data to any known sign recognition DNN (e.g., SignNet) to determine whether the frame(s) depict a street parking sign (e.g., by generating a corresponding classification score for each designated class of parking sign per image). In some embodiments (e.g., based on detecting a street parking sign), the image detection task manager 120a may apply any known segmentation technique to identify which pixels depict a sign, street parking sign, or other detected text (e.g., by generating a corresponding classification score for each designated class of parking sign per pixel), and may decode the output using any known technique to generate a corresponding bounding box or other bounding shape that contains the detected street parking sign. Additionally or alternatively, the image detection task manager 120a may generate and transmit a representation of a prompt for the VLM(s) 180 to detect whether there is a sign, a street parking sign, or other text in the frame(s) of image data, and/or (e.g., if so) to output a representation (e.g., pixel coordinates) of a bounding box or other bounding shape that contains the detected street parking sign or other detected text. Any known technique may be used to constrain the VLM(s) 180 to a structured output or otherwise extract the inferred bounding shape from the generated response.

In another example of a possible parking domain, at block 320, the image detection task manager 120a may access frames of image data from one or more (e.g., front-facing, repeater, side pillar) exterior cameras, may apply the frame(s) of image data to any known sign recognition DNN (e.g., SignNet) to determine whether the frame(s) depict a parking garage sign (e.g., by generating a corresponding classification score for each designated class of parking garage sign per image). In some embodiments (e.g., based on detecting a parking garage sign), the image detection task manager 120a may apply any known segmentation technique to identify which pixels depict a sign, parking garage sign, or other detected text (e.g., by generating a corresponding classification score for each designated class of parking garage sign per pixel), and may decode the output using any known technique to generate a corresponding bounding box or other bounding shape that contains the detected parking garage sign. Additionally or alternatively, the image detection task manager 120a may generate and transmit a representation of a prompt for the VLM(s) 180 to detect whether there is a sign, a parking garage sign, or other text in the frame(s) of image data, and/or (e.g., if so) to output a representation (e.g., pixel coordinates) of a bounding box or other bounding shape that contains the detected sign or text. Any known technique may be used to constrain the VLM(s) 180 to a structured output or otherwise extract the inferred bounding shape from the generated response. These are meant simply as non-limiting examples, and other parking domains and/or detection techniques may be implemented within the scope of the present disclosure.

In some embodiments, the image detection task manager 120a may operate the applicable block 315 or 320 to evaluate individual frames periodically (e.g., every one or two seconds) and/or at a designated frame rate. In some embodiments, the video detection task manager 110a may store a batch of frames (or corresponding visual encodings) and evaluate sampled frames from the batch periodically (e.g., every five seconds) and/or at a designated frame rate. Depending on the implementation, when the image detection task manager 120a and/or the video detection task manager 110a detects a sign (or text), at block 330, it may crop the corresponding image data to correspond to the bounding shape of the detected sign or text and/or apply the (e.g., cropped) image data to the next stage of the parking sign evaluation pipeline 300.

Depending on the implementation and/or the scenario, the detected sign or text may not actually be a parking sign (e.g., it may be a stop sign). As such, in some embodiments, at block 330, the image detection task manager 120a or video detection task manager 110a generates and transmits a representation of a prompt for the VLM(s) 180 to confirm the (e.g., cropped) image data depicts a parking sign. As with other example uses of VLM(s) described herein, any known technique may be used to constrain the VLM(s) 180 to a corresponding structured output or otherwise extract the target data from the generated response. If the VLM(s) 180 determine the (e.g., cropped) image data does not depict a parking sign, that detection may be skipped (and the parking sign evaluation pipeline 300 may continue operating, checking subsequent frames of image data for signs). If the VLM(s) 180 determine the (e.g., cropped) image data does depict a parking sign, the parking sign evaluation pipeline 300 may advance to block 340.

In some embodiments, at block 340, the image detection task manager 120a or video detection task manager 110a may confirm the legibility of the detected parking sign. For example, in some embodiments that apply sign recognition or class segmentation to detect the sign, the image detection task manager 120a or video detection task manager 110a may determine the ratio of the detected RoI relative to the full frame and apply a designated legibility threshold to the ratio (e.g., the detected RoI covers at least ten percent of the image). In some embodiments that use the VLM(s) 180 to detect the bounding shape of the sign, the image detection task manager 120a or video detection task manager 110a may generate and transmit a representation of a prompt for the VLM(s) 180 to determine whether the sign is legible (e.g., a prompt comprising a visual input that concatenates the full frame of image data with the cropped sign and a textual input that asks whether the sign is legible enough to understand). If a determination is made that the sign is not legible, that detection may be skipped (and the parking sign evaluation pipeline 300 may continue operating, checking subsequent frames of image data for signs). If a determination is made that the sign is legible, the parking sign evaluation pipeline 300 may advance.

In some embodiments, once a (e.g., legible) sign is detected, the image detection task manager 120a or video detection task manager 110a may trigger the VLM(s) 180 to evaluate the sign at block 350 at any suitable time (e.g., upon detection of the legible sign, based on the ADAS having identified a candidate parking space). For example, the image detection task manager 120a or video detection task manager 110a may cache the corresponding (e.g., cropped) image data depicting the sign (e.g., and associate it with block, street, parking garage, parking lot, or other geographic region where the detected sign was sensed, detected, or otherwise located), and the parking sign evaluation pipeline 300 may continue operating, checking subsequent frames of image data for signs and caching (e.g., cropped) image data depicting detected signs. In an example embodiment, the image detection task manager 120a or video detection task manager 110a may clear the cache associated with a particular geographic region when the ego-machine navigates outside that region. In some embodiments, the ADAS may identify candidate parking spaces using any known technique and inform the image detection task manager 120a or video detection task manager 110a when it detects a candidate parking space. As such, when the image detection task manager 120a or video detection task manager 110a is informed about a candidate parking space, it may determine the ego-machine's location using any known technique and determine whether there are any cached signs associated with that location (e.g., on the same block or street, in the same parking garage or lot, etc.).

If there is one cached sign associated with the ego-machine's location, the image detection task manager 120a or video detection task manager 110a may prompt the VLM(s) 180 to determine whether the cached sign permits parking based on one or more contextual inputs provided in the textual prompt, such as the current time, day of the week, special days (e.g., holidays or special event days), location context (e.g., presence in a region of a map, such as a school zone that imposes restrictions during certain hours, a residential zone that place restrictions on non-residents, a business district that imposes restrictions during business hours; proximity to intersections; etc.), any preconfigured (e.g., geo-tagged) parking permits, and/or user input designating a desired duration of parking time. Taking parking permits as an example, the ego-machine may include an interface (e.g., an infotainment system, a voice interface) that accepts input designating one or more characteristics of an applicable parking permit (e.g., which street(s) or other region(s) the permit authorizes the ego-machine to park on), and the characteristics may be cached (or stored in memory of the VLM(s) 180) and included (or referenced) in a prompt. Taking user input designating a desired duration of parking time as an example, an interface of the ego-machine may accept the user input in any suitable form (e.g., voice, touch, dial, etc.), and if a cached sign is ready for evaluation before the input has been provided, the image detection task manager 120a or video detection task manager 110a may trigger a digital (e.g., voice) assistant to prompt the user to provide the input. By way of nonlimiting example, a prompt for the VLM(s) 180 may include textual input such as, “Given the image of the parking sign, determine if we can park at this location for [designated duration] starting now [with a designated parking permit, if applicable].”

If there are multiple cached signs associated with the ego-machine's location, the image detection task manager 120a or video detection task manager 110a may use the most recently cached sign, or it may prompt the VLM(s) 180 to determine whether there is a conflict between signs, which sign is applicable, and/or whether it is permissible to park in the candidate parking space based on the signs. For example, the image detection task manager 120a or video detection task manager 110a may concatenate cached images of multiple signs associated with the ego-machine's location (e.g., detected from a common segment or region of a map such as the same city block or geo-fenced region) and provide the concatenated images as visual input with a textual prompt instructing the VLM(s) 180 to determine whether there is a conflict between signs, which sign is applicable, and/or whether it is permissible to park at that location based on one or more contextual inputs. As such, the VLM(s) 180 may resolve various types of ambiguities, such as overlapping days or times (e.g., one sign that says “No parking Monday 8 AM-10 AM” for street cleaning and another that says “2-hour parking Monday-Friday, 9 AM-6 PM”), conflicts between temporary and permanent signs (e.g., special event conflicts), and others.

Accordingly, at block 350, the image detection task manager 120a or video detection task manager 110a may prompt the VLM(s) 180 to determine whether it is permissible to park in a candidate parking space (e.g., represented by the associated location of the cached sign), and the VLM(s) 180 may return a corresponding response. As such, the image detection task manager 120a or video detection task manager 110a may provide the response (or a decoded representation thereof) to the ADAS to confirm or invalidate the candidate parking space, and/or may provide a representation of the validity of the candidate parking space to the operator of the ego-machine (e.g., a valid parking spaces may be visualized with green overlays and/or invalid parking spaces may be visualized with red overlays on a display). Depending on the implementation or scenario, if there are no cached signs associated with the ego-machine's location, the image detection task manager 120a or video detection task manager 110a may inform the ADAS (which may assume the candidate parking space has not been invalidated); provide the user with some feedback indicating uncertainty in the validity of candidate parking spaces; retrieve and evaluate a cached map from an external (e.g., crowdsourced) database; and/or otherwise.

In some embodiments, instead of (or in addition to) caching image data, the image detection task manager 120a or video detection task manager 110a may prompt the VLM(s) 180 to evaluate the image data, and may cache a representation of the generated results (e.g., a representation of whether or not it is permissible to park in a corresponding geographic region). The image detection task manager 120a or video detection task manager 110a may provide some representation of the results to the ADAS and/or the user (e.g., independent of whether the ADAS has identified a candidate parking space, in response to the ADAS identifying a candidate parking space). In some embodiments, instead of (or in addition to) caching image data, the image detection task manager 120a or video detection task manager 110a may trigger extraction of text from the image data (e.g., using OCR, using the VLM(s) 180), may cache the extracted text, and may apply the extracted text to the VLM(s) 180 as part of a textual prompt at any suitable time. These are just a few examples, and other variations may be implemented within the scope of the present disclosure.

In some embodiments (e.g., if the VLM(s) 180 determine at block 350 that it is permissible to park), at block 360, the image detection task manager 120a or video detection task manager 110a may generate and transmit a representation of a prompt for the VLM(s) 180 to determine the cost to park at that location (e.g., using textual input such as “How much does it cost to park for [specified duration]?”). In some embodiments, the image detection task manager 120a or video detection task manager 110a may (but need not) reapply the cached sign as an associated visual input. Although FIG. 3 illustrates an embodiment in which there are separate prompts to determine whether it is permissible to park and to determine the cost to do so, this need not be the case (e.g., textual input such as “and if it is permissible to park, what is the cost?” may be included in the prompt applied during block 350). The image detection task manager 120a or video detection task manager 110a may provide a representation of the predicted cost to park in any suitable form (e.g., visually represented on a display, audibly output using synthesized speech, etc.).

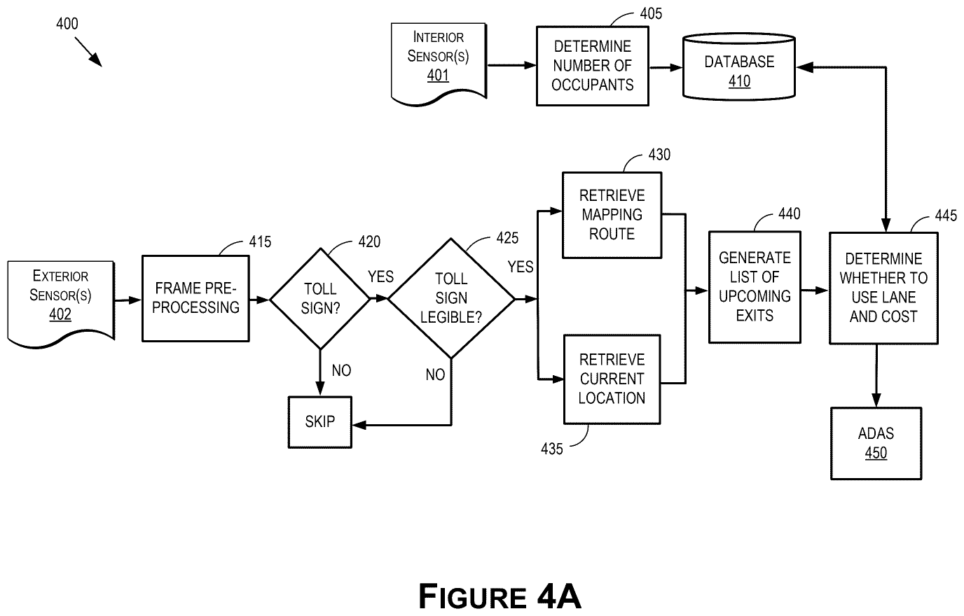

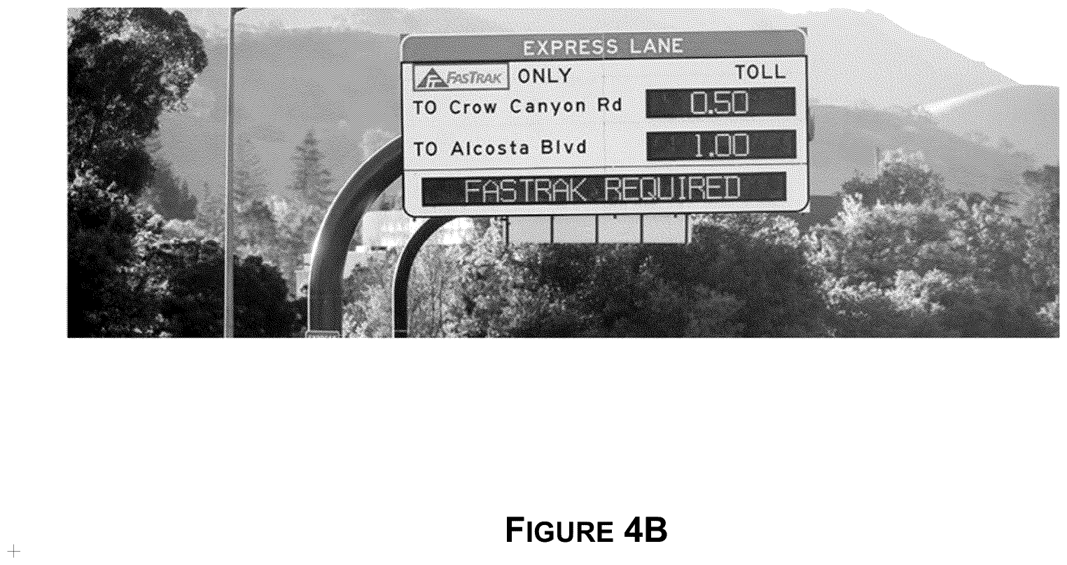

In some embodiments, the VLM(s) 180 may be used to evaluate image data representing detected sign(s) that designate restricted or toll lanes, determine whether it is permissible (and/or the cost) to merge into a restricted or toll lane, and/or determine when to merge out of a restricted or toll lane based on the cost. FIG. 4A is a data flow diagram illustrating an example toll sign evaluation pipeline 400 for evaluating a toll sign such as the one illustrated in FIG. 4B. The toll sign evaluation pipeline 400 may be implemented by the video detection task manager 110a, the image detection task manager 120a, and/or the VLM(s) 180 of FIG. 1. FIG. 1.

Taking an example implementation that evaluates images of toll signs, the image detection task manager 120a may trigger the toll sign evaluation pipeline 400 to begin evaluating frames of image data from external sensor(s) 402 of an ego-machine. For example, an ADAS such as the ADAS system 1038 of FIG. 10C may use any known technique to determine that the ego-machine has initiated or is engaged in highway driving (e.g., based on highway driving patterns, associating the ego-machine's location with known highway locations; identifying highway-specific visual features such as on-ramps or off-ramps, etc.), the ADAS may provide a signal indicating highway driving has been initiated or detected, and the image detection task manager 120a may use the signal to trigger the toll sign evaluation pipeline 400 to begin evaluating frames of image data from the external sensor(s) 402. Additionally or alternatively, the image detection task manager 120a may trigger the toll sign evaluation pipeline 400 to evaluate frames of image data from the external sensor(s) 402 periodically (e.g., to check for bridge or tunnel toll signs) and/or based on entering or approaching a geo-tagged location.

The toll sign evaluation pipeline 400 may evaluate frames of image data from external sensor(s) 402 of an ego-machine (e.g., one or more of the stereo camera(s) 1068, wide-view camera(s) 1070, infrared camera(s) 1072, surround camera(s) 1074, or long-range and/or mid-range camera(s) 1098 of the vehicle 1000 of FIGS. 10A-10D), such as images generated using a front-facing camera. In some embodiments, the image detection task manager 120a operates at least a portion of the toll sign evaluation pipeline 400 (e.g., starting at block 415) to evaluate individual frames periodically (e.g., every one or two seconds) and/or at a designated frame rate. In some embodiments, the video detection task manager 110a may store a batch of frames and evaluate sampled frames from the batch periodically (e.g., every five seconds) and/or at a designated frame rate.

Starting with an example pass through the toll sign evaluation pipeline 400, the image detection task manager 120a may retrieve or receive a frame of image data (e.g., via an API of a network data acquisition system). In some embodiments (e.g., in which the external sensor(s) 402 include one or more fisheye cameras that generate fisheye images), at block 415, the image detection task manager 120a remove distortion (e.g., barrel distortion, radial distortion) from the image data using any known technique.

In some embodiments, at block 420, the image detection task manager 120a determines whether the (e.g., processed) frame of image data depicts a toll sign and/or detects its location in the frame. For example, the image detection task manager 120a may apply the frame of image data to any known sign recognition DNN (e.g., SignNet) to determine whether the frame depicts a toll sign (e.g., by generating a corresponding classification score for each designated class of toll sign per image). In some embodiments (e.g., based on detecting a toll sign), the image detection task manager 120a may apply any known segmentation technique to identify which pixels depict a sign, toll sign, or other detected text (e.g., by generating a corresponding classification score for each designated class of toll sign per pixel), and may decode the output using any known technique to generate a corresponding bounding box or other bounding shape that contains the detected toll sign. Additionally or alternatively, the image detection task manager 120a may generate and transmit a representation of a prompt for the VLM(s) 180 to detect whether there is a sign, a toll sign, or other text in the frame(s) of image data, and/or (e.g., if so) to output a representation (e.g., pixel coordinates) of a bounding box or other bounding shape that contains the detected sign or text. When the image detection task manager 120a detects a sign (or text), it may crop the corresponding image data to correspond to the bounding shape of the detected sign or text and/or apply the (e.g., cropped) image data to the next stage of the toll sign evaluation pipeline 400. In some embodiments, the image detection task manager 120a generates and transmits a representation of a prompt for the VLM(s) 180 to confirm the (e.g., cropped) image data depicts a toll sign. If any of the foregoing steps does not detect or confirm that the frame of image data depicts a toll sign, that detection may be skipped (and the toll sign evaluation pipeline 400 may continue operating, checking subsequent frames of image data for signs). If it is determined and/or confirmed that the frame of image data depicts a toll sign, the toll sign evaluation pipeline 400 may advance to block 425.

In some embodiments, at block 425, the image detection task manager 120a may confirm the legibility of the detected toll sign (e.g., using the techniques described above with respect to block 340 of the parking sign evaluation pipeline 300 of FIG. 3). If a determination is made that the sign is not legible, that detection may be skipped (and the toll sign evaluation pipeline 400 may continue operating, checking subsequent frames of image data for signs). If a determination is made that the sign is legible, the image detection task manager 120a may cache the corresponding (e.g., cropped) image data depicting the sign and may advance the toll sign evaluation pipeline 400.

In some embodiments, once a (e.g., legible) sign is detected, at block 430, the image detection task manager 120a may retrieve an active mapping route (e.g., represented using data structure(s) such as a graph in which nodes represent intersections and edges represent roads) that identifies a planned exit from the highway. At block 435, the image detection task manager 120a may determine the ego-machine's current location using any known technique, and at block 440, the image detection task manager 120a may generate a list or other representation of the upcoming exits between the current location and the planned exit (e.g., traversing the active route using a pathfinding algorithm, collecting nodes that represent exits encountered along the way). In some embodiments, instead of retrieving an active mapping route and identifying the upcoming exits through a planned exit on the route, the image detection task manager 120a may generate a list or other representation of some (e.g., designated) number of upcoming exits on the current road.

At block 445, the image detection task manager 120a may trigger the VLM(s) 180 to evaluate the (e.g., cached, cropped) image data of the detected sign. For example, the image detection task manager 120a may prompt the VLM(s) 180 to determine whether it is permissible to drive in the toll lane and/or (e.g., if so) the cost to drive in the toll lane through one of the upcoming exits based on one or more contextual inputs (e.g., stored in a database 410, text file, memory of the VLM(s) 180, or some other structure) provided in a textual prompt, such as a designated maximum toll per journey, the current tolls accrued on the journey, the list of upcoming exits, and the planned exit (if applicable). Taking a designated maximum toll per journey as an example, the ego-machine may include an interface (e.g., an infotainment system, a voice interface) that accepts user input designating a desired maximum toll (e.g., for the current journey or route, a pre-configured or default), and if a cached sign is ready for evaluation before the input has been provided, the image detection task manager 120a may trigger a digital (e.g., voice) assistant to prompt the user to provide the input. Taking the current tolls accrued on the journey as an example, the image detection task manager 120a may maintain a running sum of the total (e.g., in the database 410). If a determination is made (e.g., by the VLM(s) 180, by the ADAS 450) to take the toll road, the image detection task manager 120a may extract the cost determined by the VLM(s) 180, add it to the running total, and store the updated sum (e.g., in the database 410) for inclusion in a subsequent prompt. This way, the VLM(s) 180 may consider a designated maximum toll and the total amount spent on tolls so far on the journey.

In some implementations when the highway tolling and payment system depends on the number of occupants in the vehicle, an on-board OMS and/or the VLM(s) 180 may be used to determine the number of machine occupants or operators, and the number may be included in the prompt. For example, the ego-machine may include one or more interior sensors 401 (an OMS or DMS camera such as the OMS sensor(s) 1001 of the vehicle 1000), the image detection task manager 120a may retrieve or receive one or more frame(s) of image data generated using the interior sensor(s) 401 (e.g., via an API of a network data acquisition system, when the ego-machine is turned on, in response to a door opening or closing, in response to the ego-machine initiating a journey, etc.), and the image detection task manager 120a may determine the number of occupants depicted in the frame(s) of image data. For example, the image detection task manager 120a may use any known object detection technique to detect, localize, count, predict, or otherwise determine the number of distinct human occupants. In some embodiments, the image detection task manager 120a generates and transmits a representation of a prompt for the VLM(s) 180 to determine the number of human occupants depicted in the frame(s) of image data. As such, the image detection task manager 120a may determine and store the number of occupants (e.g., in the database 410, a text file, or some other structure) for inclusion in a subsequent prompt.

Taking a highway tolling and payment system that provides signs that list the tolls required to travel on upcoming toll roads, a prompt for the VLM(s) 180 may include textual input such as, “Given the image of the [Highway Tolling System Name] toll sign, determine if we can be in the [e.g., FasTrak] lane. The toll sign has roads listed with the tolls that we need to pay to travel to that road. [If applicable: {There are two occupants in the car, so the toll is reduced by half.; There are three or more occupants in the car, so the toll is free for all exits}.] We can spend a maximum of <designated maximum toll>. We have spent <total spent on tolls> so far. Here is the list of the upcoming exits: <list>. [If applicable: The last exit we will take is <exit>.] Can we be in the HOV lane, and, if so, how much money will we spend to get the next exit? Think step-by-step.”

As such, at block 445, the image detection task manager 120a may prompt the VLM(s) 180 to determine whether to use a toll lane (e.g., whether it can be taken within budget), and/or what the cost would be, and the VLM(s) 180 may return a corresponding response. Accordingly, the image detection task manager 120a may provide the response (or a decoded representation thereof) to the ADAS 450 to trigger a corresponding navigational decision and/or maneuver. For example, when driving outside of the toll lane, the VLM(s) 180 may be used to evaluate a toll sign indicating the toll for an upcoming road segment and determine whether to enter the toll lane (e.g., in which case the ADAS 450 may initiate a merge operation) or not to enter the toll lane (e.g., in which case the ADAS 450 may determine not to initiate a merge operation, or may initiate a merge into some other lane besides the toll lane). When driving in the toll lane, the VLM(s) 180 may be used to evaluate a toll sign indicating the toll for an upcoming road segment and determine whether to remain in the toll lane (e.g., in which case the ADAS 450 may determine not to initiate a merge operation) or exit the toll lane (e.g., in which case the ADAS 450 may initiate a merge operation). In some embodiments, the image detection task manager 120a may provide a representation of the decision, the detected toll, and/or the total spent (or planned to be spent) on an upcoming road segment to the operator of the ego-machine (e.g., visualized on a display, audibly output using synthesized speech, etc.). In some embodiments, the image detection task manager 120a may prompt for, or otherwise accept, input from the operator or occupant increasing a designated budget or accepting a detected toll, in which case, the image detection task manager 120a may update the designated budget and/or provide the ADAS 150 with a representation of an instruction to take or remain in the toll lane. The detection tasks described herein are meant simply as examples, and those of ordinary skill in the art will understand how to implement variations and other detection tasks.

Returning to FIG. 1, in some embodiments, one or more of the VLM(s) 180 may be used to support different types of detection tasks (e.g., one foundational VLM supporting some or all detection tasks performed by an ego-machine, one VLM for interior sensing tasks and one for exterior sensing tasks, one VLM for image detection tasks and one for video detection tasks, etc.). As such, the prompt scheduler 150 may be used to serve or handle inference requests for the VLM(s) 180.

Generally, the prompt scheduler 150 may orchestrate the timing and sequence of input prompts issued by the video detection task manager(s) 110a-n and/or the image detection task manager(s) 120a-n and the corresponding inference tasks performed by the VLM(s) 180. Since the VLM(s) 180 may process multimodal prompts, the prompt scheduler 150 may coordinate application of the different types of inputs in a prompt (e.g., visual data such as an image or a representation of sampled frames, textual input such as a question) to corresponding input channels of the VLM(s) 180 (e.g., a VLM specified by or associated with a particular request or detection task manager).

Depending on the implementation, task, and/or scenario, the video detection task manager(s) 110a-n and/or the image detection task manager(s) 120a-n may issue inference requests (e.g., prompts) in response to some event (e.g., prompting the VLM to perform hands-on-wheel detection when the ego-machine is engaged in level 1 or 2 automation, prompting the VLM to perform child presence detection when a driver and/or occupant exits the vehicle and shuts the door) and/or periodically (e.g., prompting the VLM to determine whether the driver is distracted every few seconds). Taking an example detection task that operates over some temporal context window (e.g., drowsiness or distraction detection), the video detection task manager 110a may encode, queue (e.g., in the frame queue 112a), and periodically issue a prompt that identifies a textual input and a representation of some designated number of sampled frames from a (e.g., sliding) window as visual input. Depending on the task and/or the implementation, the video detection task manager 110a may submit periodic inference requests for the VLM(s) 180 to the prompt scheduler 150 in response to receiving a response or other indication that a previous periodic inference request has been completed, at some fixed rate (e.g., 30 or 60 fps), or otherwise. Generally, the video detection task manager(s) 110a-n and/or the image detection task manager(s) 120a-n may submit inference requests at different times and/or rates. As such, the prompt scheduler 150 may queue, manage, and distribute inference requests from different detection applications to the VLM(s) 180, and receive and return responses from the VLM(s) 180 to the corresponding video detection task manager(s) 110a-n and/or image detection task manager(s) 120a-n.

In some embodiments, the prompt scheduler 150 includes a prompt prioritization component 155 that prioritizes inference requests based on safety. For example, the prompt prioritization component 155 may prioritize inference requests from some detection task manager(s) over inference requests from other detection task manager(s) (e.g., prioritizing inference requests to perform ADAS tasks such as pedestrian detection, bicycle detection, or trajectory planning over requests to perform driver or occupant monitoring tasks, prioritizing exterior sensing tasks over interior sensing tasks, etc.).

Depending on the implementation and/or the scenario, the prompt scheduler 150 may queue and/or manage multiple inference requests at any given time. For example, drowsiness and/or distraction detection requests may be submitted periodically (e.g., every 2 seconds), sign evaluation requests may be submitted periodically (e.g., every 5-10 seconds), requests to evaluate candidate trajectories may be submitted on demand (e.g., multiple times per second), and/or other types of requests for interior or exterior sensing tasks may be submitted (e.g., lane detection, object detection, sign recognition, context-aware question answering of contextual inquiries to answer user questions about a scene, requests to determine whether a designated object has been left behind, suspicious activity monitoring such as intrusion detection (e.g., sentry mode) requests to detect whether a nearby person has some kind of malicious intent, etc.).

As such, the prompt prioritization component 155 may assign a priority to inference requests based on safety such that inference requests from tasks deemed more important to safety may be served before inference requests from lower priority tasks deemed less important to safety. Any suitable safety prioritization scheme may be used to prioritize or otherwise classify detection tasks based on safety (e.g., based on some pre-determined prioritization hierarchy), and the prompt prioritization component 155 may assign some representation of priority to inference requests based on the prioritization scheme (e.g., upon receiving the inference request, at inference time, etc.). For example, an ADAS task such as trajectory planning may be assigned a relatively higher priority P1 (e.g., using some identifier such as an integer), and a detection task such as drowsiness detection may be assigned a relatively lower priority P0. As such, the prompt prioritization component 155 may store trajectory planning inference requests in a priority queue corresponding to the higher priority P1, may store drowsiness detection requests in a lower priority queue corresponding to the lower priority P0, and may prioritize inference requests from the priority queue over the lower priority queue. In another example, the prompt prioritization component 155 may store inference requests from different tasks in the same queue with a representation of corresponding assigned priorities, and may select inference requests from the queue based on the assigned priorities of the queued requests. In some embodiments, the prompt prioritization component 155 may generate and transmit a representation of a prompt for the VLM(s) 180 to prioritize or otherwise classify detection tasks based on safety (e.g., to generate a pre-determined prioritization hierarchy, resolving prioritization decisions on demand based on the in-flight requests, etc.). These are just a few examples, and other variations may be implemented within the scope of the present disclosure.

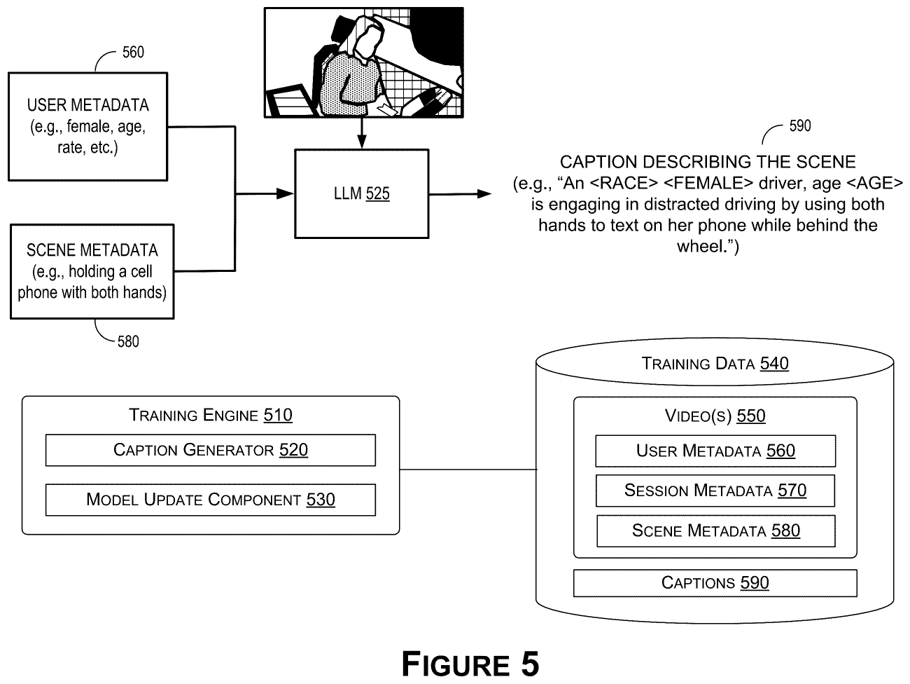

In some embodiments, the VLM(s) 180 may be selected and/or trained using any known technique. For example, the VLM(s) 180 may include a pre-trained or foundational VLM and/or LLM, and may be fine-tuned for any applicable detection task using any known technique. In some embodiments, the VLM(s) 180 may be trained (e.g., fine-tuned) using (e.g., dense) captions generated using an LLM. FIG. 5 illustrates an example training technique that uses generated captions.

At a high level, one or more videos 550 and corresponding captions 590 may be used as training data 540. In some embodiments, a training engine 510 may be used to generate the captions 590. Taking an example detection task such as (e.g., video) monitoring of a driver or occupant, one or more participants may be instructed to perform one or more actions (e.g., remove their seatbelt, adjust the rearview mirror, use both hands to text on the phone, etc.), and video(s) 550 (e.g., 30 second clips) of the actions may be recorded and may be provided to the training engine 510 or otherwise identified. The training engine 510 may associate the video(s) 550 and/or corresponding video frames with corresponding metadata (e.g., user metadata 560 representing driver or occupant attributes populated based on questionnaire responses, session metadata 570 representing session attributes such as time of day or number of people in the car populated based on known conditions, scene metadata 580 representing instructed actions, camera metadata indicating where the camera is positioned or how it is oriented, etc.), and a caption generator 520 of the training engine 510 may generate and provide a representation of a prompt for an LLM 525 (e.g., the example generative LLM system 1100 of FIG. 11A, the generative LLM 1130 of FIGS. 11A, 11B, or 11C) to generate a (e.g., dense) caption based on the user metadata 560, the session metadata 570, the scene metadata 580, and/or the camera metadata. As such, the LLM 525 may generate and return captions that describe a corresponding video(s) 550 and/or corresponding video frames, and the caption generator 520 may store and associate the generated captions 590 with corresponding video(s) 550.

As such, a model update component 530 of the training engine 510 may use the video(s) 550 and corresponding captions 590 to train a VLM (e.g., the VLM(s) 180 of FIG. 1) using auto-regressive training. For example, the model update component 530 may prompt the VLM to sequentially predict one of the captions 590 based on a sequence of frames sampled from a corresponding one of the video(s) 550 to provide temporal context (e.g., using similar functionality as the video detection task manager 110a of FIG. 1). Accordingly, the model update component 530 may train (e.g., fine-tune) the VLM to perform any number and/or type of detection tasks (e.g., driver monitoring tasks, occupant monitoring tasks, environmental text perception tasks, etc.).

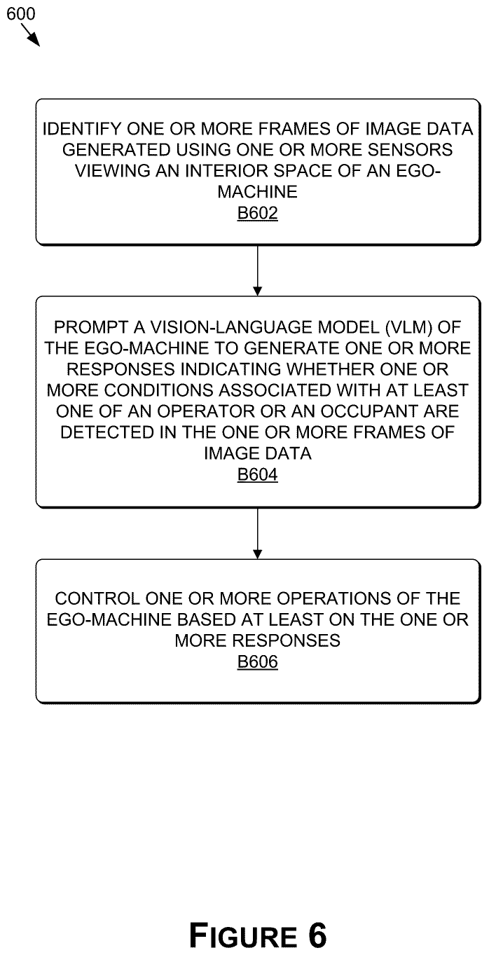

Now referring to FIGS. 6-9, each block of methods 600-900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a standalone service, a hosted service (standalone or in combination with another hosted service), or a plug-in to another product, to name a few. In addition, the methods may be described, by way of example, with respect to the detection pipeline 100. However, these methods may additionally or alternatively be executed by any one system, or any combination of systems, including, but not limited to, those described herein.

FIG. 6 is a flow diagram showing a method 600 for evaluating whether one or more conditions associated with at least one of an operator or an occupant are detected in one or more frames of image data, in accordance with some embodiments of the present disclosure. The method 600, at block B602, includes identifying one or more frames of image data generated using one or more sensors viewing an interior space of an ego-machine. For example, with respect to the detection pipeline 100 of FIG. 1, the sensor(s) 105 may be used to generate frame(s) of sensor data representing an interior space, and the video detection task manager 110a and/or the image detection task manager 120a may retrieve or receive the frame(s) of sensor data (e.g., via an API of a network data acquisition system). Depending on the detection task, the video detection task manager 110a and/or image detection task manager 120a may retrieve or receive frame(s) from certain sensor(s) (e.g., a particular OMS or DMS camera). Generally, the video detection task manager 110a and/or image detection task manager 120a may determine when to perform an inference for a corresponding detection task (e.g., at a given frame rate, triggered by an event), and determine which sensor data to evaluate during a given inference. For image detection tasks, the image detection task manager 120a may identify a single frame (e.g., an image) for each inference. For video detection tasks, the video detection task manager 110a may store frames of sensor data from a sliding temporal window (or may use a corresponding vision encoder to generate and store visual embeddings for the frames) in the frame queue 112a, and may identify a plurality of sampled frames (or corresponding visual embeddings) from the frame queue 112a for each inference.

The method 600, at block B604, includes prompting a vision-language model (VLM) of the ego-machine to generate one or more responses indicating whether one or more conditions associated with at least one of an operator or an occupant are detected in the one or more frames of image data. For example, with respect to the detection pipeline 100 of FIG. 1, the video detection task manager 110a and/or image detection task manager 120a may prompt the VLM(s) 180 (e.g., via the prompt scheduler 150) to perform a corresponding detection task by evaluating corresponding sensor data.

The method 600, at block B606, includes controlling one or more operations of the ego-machine based at least on the one or more responses. For example, with respect to the detection pipeline 100 of FIG. 1, the VLM(s) 180 may return a response indicating the result(s) of the requested detection task. As such, the video detection task manager 110a and/or image detection task manager 120a may provide a corresponding control component(s) 190 with a representation of the result(s), and the control component(s) 190 may take some responsive action. Generally, the sensor(s) 105, the control component(s) 190, and/or the responsive action may depend on the detection task and/or the implementation.

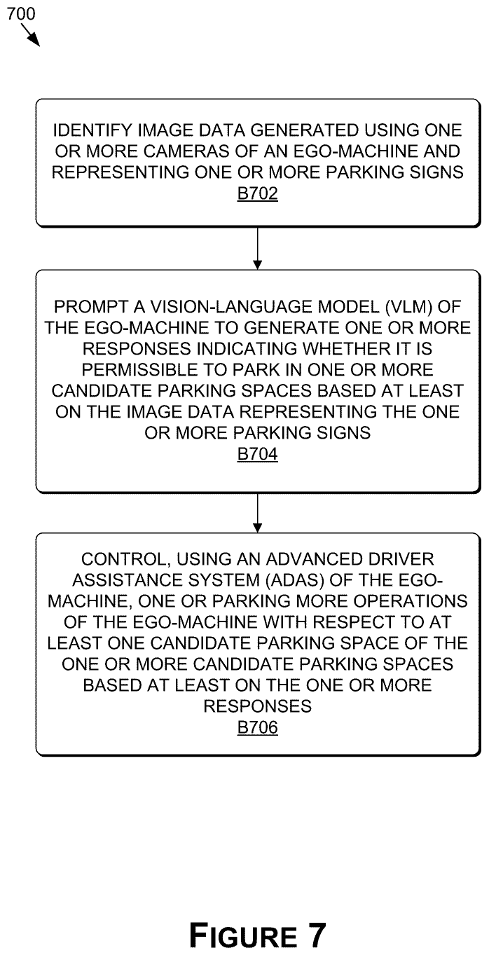

FIG. 7 is a flow diagram showing a method 700 for evaluating whether it is permissible to park in one or more candidate parking spaces, in accordance with some embodiments of the present disclosure. The method 700, at block B702, includes identifying image data generated using one or more cameras of an ego-machine and representing one or more parking signs. For example, with respect to the parking sign evaluation pipeline 300 of FIG. 3, at block 315 or 320, the image detection task manager 120a or the video detection task manager 110a of FIG. 1 may access frames of image data from one or more (e.g., front-facing, repeater, side pillar) exterior cameras, and may apply the frame(s) of image data to any known sign recognition DNN (e.g., SignNet), segmentation technique, and/or the VLM(s) 180 to determine whether the frame(s) depict a parking sign, a sign, or other detected text. At block 330, the image detection task manager 120a or video detection task manager 110a may generate and transmit a representation of a prompt for the VLM(s) 180 to confirm the (e.g., cropped) image data depicts a parking sign, and at block 340, the image detection task manager 120a or video detection task manager 110a may confirm the legibility of the detected parking sign using the VLM(s) 180.

The method 700, at block B704, includes prompting a vision-language model (VLM) of the ego-machine to generate one or more responses indicating whether it is permissible to park in one or more candidate parking spaces based at least on the image data representing the one or more parking signs. For example, with respect to the parking sign evaluation pipeline 300 of FIG. 3, at block 350, the image detection task manager 120a or video detection task manager 110a may prompt the VLM(s) 180 to determine whether the (e.g., cached, cropped) sign permits parking based on one or more contextual inputs provided in a textual prompt.

The method 700, at block B706, includes controlling, using an Advanced Driver Assistance System (ADAS) of the ego-machine, one or more parking operations of the ego-machine with respect to at least one candidate parking space of the one or more candidate parking spaces based at least on the one or more responses. For example, with respect to the detection pipeline 100 of FIG. 1, the image detection task manager 120a or video detection task manager 110a may provide the response from the VLM(s) 180 (or a decoded representation thereof) to an ADAS to confirm or invalidate the candidate parking space, and/or may provide a representation of the validity of the candidate parking space to the operator of the ego-machine (e.g., a valid parking spaces may be visualized with green overlays and/or invalid parking spaces may be visualized with red overlays on a display).

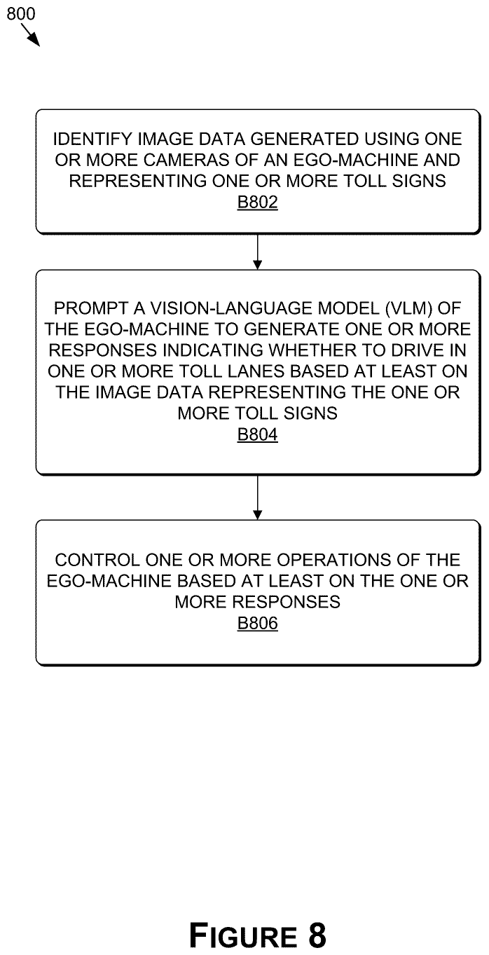

FIG. 8 is a flow diagram showing a method 800 for evaluating whether to drive in one or more toll lanes, in accordance with some embodiments of the present disclosure. The method 800, at block B802, includes identifying image data generated using one or more cameras of an ego-machine and representing one or more toll signs. For example, with respect to the toll sign evaluation pipeline 400 of FIG. 4, at block 420, the image detection task manager 120a or the video detection task manager 110a of FIG. 1 may access frames of image data from one or more (e.g., front-facing, repeater, side pillar) exterior cameras, and may apply the frame(s) of image data to any known sign recognition DNN (e.g., SignNet), segmentation technique, and/or the VLM(s) 180 to determine whether the frame(s) depict a toll sign, a sign, or other detected text. At block 425, the image detection task manager 120a or video detection task manager 110a may confirm the legibility of the detected parking sign using the VLM(s) 180.

The method 800, at block B804, includes prompting a vision-language model (VLM) of the ego-machine to generate one or more responses indicating whether to drive in one or more toll lanes based at least on the image data representing the one or more toll signs. For example, with respect to the toll sign evaluation pipeline 400 of FIG. 4, at block 445, the image detection task manager 120a or video detection task manager 110a may prompt the VLM(s) 180 to evaluate the (e.g., cached, cropped) sign and determine whether to use the corresponding toll lane (e.g., whether it can be taken within budget) based on one or more contextual inputs provided in a textual prompt, such as a designated maximum toll per journey, the current tolls accrued on the journey, the list of upcoming exits, and the planned exit (if applicable).

The method 800, at block B806, includes controlling one or more operations of the ego-machine based at least on the one or more responses. For example, with respect to the detection pipeline 100 of FIG. 1, the VLM(s) 180 may return a corresponding response, and the image detection task manager 120a may provide the response (or a decoded representation thereof) to the ADAS 450 to trigger a corresponding navigational decision and/or maneuver.

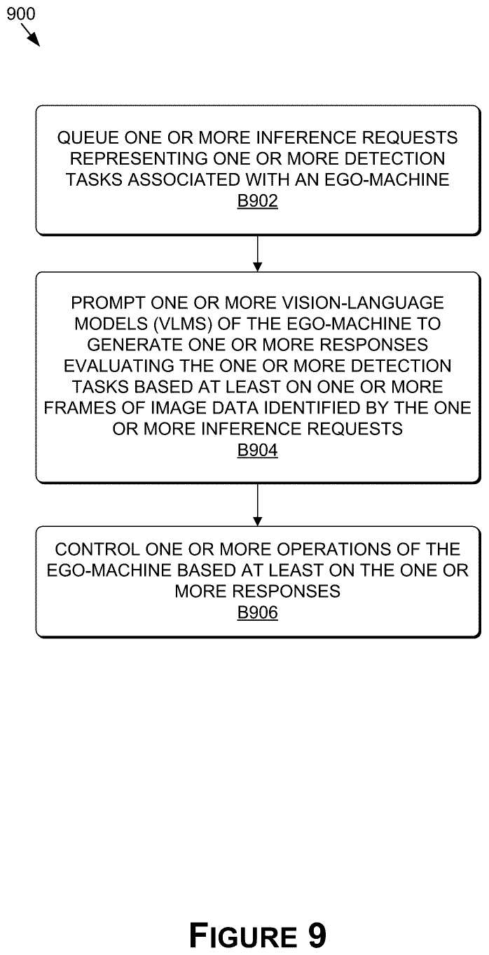

FIG. 9 is a flow diagram showing a method 900 for evaluating one or more detection tasks identified by one or more inference requests, in accordance with some embodiments of the present disclosure. The method 900, at block B902, includes queueing one or more inference requests representing one or more detection tasks associated with an ego-machine. For example, with respect to the detection pipeline 100 of FIG. 1, the video detection task manager(s) 110a-n and/or the image detection task manager(s) 120a-n may issue inference requests (e.g., prompts) for the VLM(s) 180 to the prompt scheduler 150, and the prompt scheduler 150 may queue, store, or otherwise manage the inference requests.

The method 900, at block B904, includes prompting one or more vision-language models (VLMs) of the ego-machine to generate one or more responses evaluating the one or more detection tasks based at least on one or more frames of image data identified by the one or more inference requests. For example, with respect to the detection pipeline 100 of FIG. 1, the prompt scheduler 150 may distribute inference requests from different detection applications to the VLM(s) 180. In some embodiments, the prompt scheduler 150 includes a prompt prioritization component 155 that prioritizes inference requests based on safety.

The method 900, at block B906, includes controlling one or more operations of the ego-machine based at least on the one or more responses. For example, with respect to the detection pipeline 100 of FIG. 1, the prompt scheduler 150 may receive and return responses from the VLM(s) 180 to the corresponding video detection task manager(s) 110a-n and/or image detection task manager(s) 120a-n, which may provide a corresponding control component(s) 190 with a representation of the result(s), and the control component(s) 190 may take some responsive action.

The systems and methods described herein may be used by—or may be used in combination with—without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), generative AI applications, language model applications (e.g., large language models (LLMs), vision language models (VLMs), etc.), collaborative content creation for 3D assets, cloud computing, and/or any other suitable applications.

For example, the present techniques (e.g., the detection pipeline 100 of FIG. 1, the parking sign evaluation pipeline 300 of FIG. 3, the toll sign evaluation pipeline 400 of FIG. 4, some portion thereof, etc.) may be used in various robotics implementations (e.g., by a robot navigating a surface or objects in a warehouse), may be used within a simulation such as NVIDIA DRIVE Sim™ (e.g., using virtual sensors and/or ray-tracing to generate simulated input data corresponding to one or more of the components described herein, using real and/or simulated input data to generate simulated ground truth data, using real and/or simulated data to train or validate a neural network such as those described herein or a classical machine learning model, etc.), and/or otherwise. Generally, a simulation may be used to create simulated datasets that replicate various real-world conditions (e.g., that may be difficult or dangerous to observe in the real world), and training or validating a neural network or classical machine learning model within a simulation may expose these models to a range of (e.g., rare or dangerous) scenarios in a controlled and safe environment.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems for performing generative AI operations, systems implemented at least partially in a data center, systems for performing conversational AI operations, systems implementing one or more language models—such as one or more large language models (LLMs), vision language models (VLMs), one or more multi-modal language models, etc., systems for hosting real-time streaming applications, system for presenting one or more of virtual reality content, augmented reality content, or mixed reality content, systems for performing light transport simulation, systems for performing collaborative content creation for 3D assets, systems implemented at least partially using cloud computing resources, and/or other types of systems.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated sensor data (e.g., images of a simulated environment such as highway or warehouse environment generated from the perspective of one or more virtual sensors of a simulated ego-machine) may be applied to a VLM to perform one or more detection tasks (e.g., perceiving environmental text or one or more features of a simulated occupant), and the VLM's response may be used to control the simulated ego-machine within the simulated environment. These simulated operations may be used to test performance of the underlying algorithms, systems, and/or processes prior to deploying them in the real-world. In some instances, the simulation may be used to generate synthetic training data—e.g., images of a simulated environment generated from the perspective of one or more virtual sensors of a simulated ego-machine, and the synthetic training data (in addition to or alternatively from real-world data) may be used to train a VLM. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

### Example Autonomous Vehicle

FIG. 10A is an illustration of an example autonomous or semi-autonomous vehicle or machine 1000, in accordance with some embodiments of the present disclosure. The autonomous or semi-autonomous vehicle or machine 1000 (alternatively referred to herein as the “vehicle 1000,” “machine 1000,” “ego-vehicle 1000,” “ego-machine 1000,” “robot 1000,” etc.) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to allow the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to allow autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LiDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), one or more occupant monitoring system (OMS) sensor(s) 1001 (e.g., one or more interior cameras), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

Cameras with a field of view that include portions of the interior environment within the cabin of the vehicle 1000 (e.g., one or more OMS sensor(s) 1001) may be used as part of an occupant monitoring system (OMS) such as, but not limited to, a driver monitoring system (DMS). For example, OMS sensors (e.g., the OMS sensor(s) 1001) may be used (e.g., by the controller(s) 1036) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation allowing any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 1004 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. Pat. No. 10,885,698, issued on Jan. 5, 2021. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LiDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1016 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to allow communication with peripherals, audio codecs, power management, and/or other devices. The SoC(s) 1004 may be used to process data from cameras (e.g., connected over Gigabit Multimedia Serial Link and Ethernet), sensors (e.g., LiDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to allow wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated using the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LiDAR sensor(s) 1064. The LiDAR sensor(s) 1064 may be used for object and pedestrian detection, emergency braking, collision avoidance, and/or other functions. The LiDAR sensor(s) 1064 may be functional safety level ASIL B. In some examples, the vehicle 1000 may include multiple LiDAR sensors 1064 (e.g., two, four, six, etc.) that may use Ethernet (e.g., to provide data to a Gigabit Ethernet switch).

In some examples, the LiDAR sensor(s) 1064 may be capable of providing a list of objects and their distances for a 360-degree field of view. Commercially available LiDAR sensor(s) 1064 may have an advertised range of approximately 1000 m, with an accuracy of 2 cm-3 cm, and with support for a 1000 Mbps Ethernet connection, for example. In some examples, one or more non-protruding LiDAR sensors 1064 may be used. In such examples, the LiDAR sensor(s) 1064 may be implemented as a small device that may be embedded into the front, rear, sides, and/or corners of the vehicle 1000. The LiDAR sensor(s) 1064, in such examples, may provide up to a 120-degree horizontal and 35-degree vertical field-of-view, with a 200 m range even for low-reflectivity objects. Front-mounted LiDAR sensor(s) 1064 may be configured for a horizontal field of view between 45 degrees and 135 degrees. FIG. 10B illustrates example long-range and short-range horizontal fields-of-view for a LiDAR sensor 1064 with an example mounting location above the windshield, but other configurations such as those that include a grille-mounted LiDAR sensor 1064 (e.g., as illustrated in FIG. 10A) and/or a roof-mounted LiDAR scanner (e.g., for a data collection vehicle) are possible.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 1000. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may allow the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LiDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. As such, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(D) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Inference and Training Logic

One or more embodiments may be implemented using inference and/or training logic to perform inferencing and/or training operations. Details regarding inference and/or training logic are provided below.

In at least one embodiment, inference and/or training logic may include, without limitation, code and/or data storage to store forward and/or output weight and/or input/output data, and/or other parameters to configure. neurons or layers of a neural network trained and/or used for inferencing in aspects of one or more embodiments. In at least one embodiment, training logic may include, or be coupled to code and/or data storage to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage may be included with other on-chip or off-chip data storage, including a processor's L1, L2, or L3 cache or system memory.

In at least one embodiment, any portion of code and/or data storage may be internal or external to one or more processors or other hardware logic devices or circuits. In at least one embodiment, code and/or data storage may be cache memory, dynamic randomly addressable memory (“DRAM”), static randomly addressable memory (“SRAM”), non-volatile memory (e.g., Flash memory), or other storage. In at least one embodiment, choice of whether code and/or data storage is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic may include, without limitation, a code and/or data storage to store backward and/or output weight and/or input/output data corresponding to neurons or layers of a neural network trained and/or used for inferencing in aspects of one or more embodiments. In at least one embodiment, code and/or data storage stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic may include, or be coupled to code and/or data storage to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage may be included with other on-chip or off-chip data storage, including a processor's L1, L2, or L3 cache or system memory. In at least one embodiment, any portion of code and/or data storage may be internal or external to on one or more processors or other hardware logic devices or circuits. In at least one embodiment, code and/or data storage may be cache memory, DRAM, SRAM, non-volatile memory (e.g., Flash memory), or other storage. In at least one embodiment, choice of whether code and/or data storage is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage and code and/or data storage may be separate storage structures. In at least one embodiment, code and/or data storage and code and/or data storage may be same storage structure. In at least one embodiment, code and/or data storage and code and/or data storage may be partially same storage structure and partially separate storage structures. In at least one embodiment, any portion of code and/or data storage and code and/or data storage may be included with other on-chip or off-chip data storage, including a processor's L1, L2, or L3 cache or system memory.

In at least one embodiment, inference and/or training logic may include, without limitation, one or more arithmetic logic unit(s) (“ALU(s)”), including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage that are functions of input/output and/or weight parameter data stored in code and/or data storage and/or code and/or data storage. In at least one embodiment, activations stored in activation storage are generated according to linear algebraic and or matrix-based mathematics performed by ALU(s) in response to performing instructions or other code, wherein weight values stored in code and/or data storage and/or code and/or data storage are used as operands along with other values, such as bias values, gradient information, momentum values, or other parameters or hyperparameters, any or all of which may be stored in code and/or data storage or code and/or data storage or another storage on or off-chip.

In at least one embodiment, ALU(s) are included within one or more processors or other hardware logic devices or circuits, whereas in another embodiment, ALU(s) may be external to a processor or other hardware logic device or circuit that uses them (e.g., a co-processor). In at least one embodiment, ALU(s) may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage, code and/or data storage, and activation storage may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage may be included with other on-chip or off-chip data storage, including a processor s L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage may be cache memory, DRAM, SRAM, non-volatile memory (e.g., Flash memory), or other storage. In at least one embodiment, activation storage may be completely or partially within or external to one or more processors or other logical circuits. In at least one embodiment, choice of whether activation storage is internal or external to a processor, for example, or comprised of DRAM, SRAM, Hash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic may be used in conjunction with central processing unit (“CPU”) hardware, graphics processing unit (“GPU”) hardware or other hardware, such as field programmable gate arrays (“FPGAs”).

In at least one embodiment, inference and/or training logic may include, without limitation, hardware logic in which computational resources are dedicated or otherwise exclusively used in conjunction with weight values or other information corresponding to one or more layers of neurons within a neural network. In at least one embodiment, inference and/or training logic may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic may be used in conjunction with central processing unit (CPU) hardware, graphics processing unit (GPU) hardware or other hardware, such as field programmable gate arrays (FPGAs). In at least one embodiment, inference and/or training logic includes, without limitation, code and/or data storage and code and/or data storage, which may be used to store code (e.g., graph code), weight values and/or other information, including bias values, gradient information, momentum values, and/or other parameter or hyperparameter information. In at least one embodiment, each of code and/or data storage and code and/or data storage is associated with a dedicated computational resource, such as computational hardware and computational hardware. In at least one embodiment, each of computational hardware and computational hardware comprises one or more ALUs that perform mathematical functions, such as linear algebraic functions, only on information stored in code and/or data storage and code and/or data storage, respectively, result of which is stored in activation storage.

In at least one embodiment, each of code and/or data storage and corresponding computational hardware correspond to different layers of a neural network, such that resulting activation from one storage/computational pair of code and/or data storage and computational hardware is provided as an input to storage/computational pair of code and/or data storage and computational hardware, in order to mirror conceptual organization of a neural network. In at least one embodiment, each of storage/computational pairs may correspond to more than one neural network layer. In at least one embodiment, additional storage/computation pairs (not shown) subsequent to or in parallel with storage computation pairs may be included in inference and/or training logic.

### Example Large Language Models

Large language models (LLMs) are a type of generative artificial intelligence (AI) that can understand, summarize, translate, or otherwise generate human-like text based on the context provided in input prompts or queries. These language models are often considered “large” based on their training on massive datasets and having architectures with large number of learnable network parameters (weights and biases), with popular LLMs having millions or billions of parameters. LLMs have become proficient in summarizing textual data, analyzing and extracting insights from data, and generating new text in user-specified styles, tones, or formats. Some LLMs like the early versions of chatbots (e.g., ChatGPT) focus exclusively on text processing, whereas some multimodal LLMs can accept, understand, and/or generate text along with other types of content like images, audio, and/or video. For example, visual language models (VLMs) are a type of LLM that can accept visual and textual input and/or generate visual and textual output.

There are different types of LLM architectures that use different techniques for understanding and generating human-like text. Some early LLM architectures used recurrent neural networks (RNNs) or long short-term memory networks (LSTMs), whereas many modern LLMs use a transformer architecture that relies on self-attention mechanisms to understand and recognize relationships between words or tokens. An LLM may include encoder and/or decoder block(s). Discriminative or encoder-only LLMs like BERT (Bidirectional Encoder Representations from Transformers) are well-suited for tasks that involve language comprehension such as classification, sentiment analysis, question answering, and named entity recognition. Generative or decoder-only LLMs like GPT (Generative Pretrained Transformer) are well-suited for tasks that involve language and content generation such as text completion, story generation, and dialogue generation. LLMs that include both encoder and decoder components like T5 (Text-to-Text Transformer) can understand and generate content, making these models well-suited for tasks such as translation and summarization.

LLMs are primarily trained using unsupervised learning, in which an LLM learns patterns from large amounts of unlabeled text data. Due to their extensive training, LLMs often do not require task-specific or domain-specific training. These types of LLMs that have undergone extensive pre-training on vast amounts of unlabeled text data are often referred to as foundation models and are adept at a variety of tasks like question-answering, summarization, filling in missing information, and translation. Some LLMs may be tailored for a specific use case using techniques like prompt tuning, fine-tuning, and/or adding adapters.

FIG. 11A is a block diagram of an example generative LLM system 1100 suitable for use in implementing some embodiments of the present disclosure. In the example illustrated in FIG. 11A, the generative LLM system 1100 includes an input processor 1105, a tokenizer 1110, an embedding component 1120, and a generative LLM 1130.

At a high level, the input processor 1105 may receive an input 1101 comprising text and other types of input data, depending on the architecture of the generative LLM 1130. Typically, the input 1101 includes plain text in the form of one or more sentences, paragraphs, or documents. Additionally or alternatively, the input 1101 may include numerical sequences, precomputed embeddings (e.g., word or sentence embeddings), and/or structured data (e.g., in tabular formats, JSON, or XML). In some implementations in which the generative LLM 1130 is capable of processing multimodal inputs, the input 1101 may combine text with image data, audio data, and/or other types of input data. Taking raw input text as an example, the input processor 1105 may prepare raw input text in various ways. For example, the input processor 1105 may perform various types of text cleaning to remove noise (e.g., special characters, punctuation, HTML tags, stopwords) from relevant textual content. In an example involving stopwords (common words that tend to carry little semantic meaning), the input processor 1105 may remove stopwords to reduce noise and focus the generative LLM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

The tokenizer 1110 may segment the (e.g., processed) text into smaller units (tokens) for subsequent analysis and processing. The tokens may represent individual words, subwords, or characters, depending on the implementation. Word-based tokenization divides the text into individual words, treating each word as a separate token. Subword tokenization breaks down words into smaller meaningful units (e.g., prefixes, suffixes, stems), enabling the generative LLM 1130 to understand morphological variations and handle out-of-vocabulary words more effectively. Character-based tokenization represents each character as a separate token, enabling the generative LLM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1101 includes image data, the input processor 1105 may resize the image data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some implementations in which the input 1101 includes audio data, the input processor 1105 may resample an audio file to a consistent sampling rate for uniform processing, and the embedding component 1120 may use any known technique to extract and encode audio features. In some implementations in which the input 1101 includes video data, the input processor 1105 may extract frames or apply resizing to extracted frames, and the embedding component 1120 may extract features such as optical flow embeddings or video embeddings and/or may encode temporal information or sequences of frames. In some implementations in which the input 1101 includes multimodal data, the embedding component 1120 may fuse representations of the different types of data (e.g., text, image, audio) using techniques like early fusion (concatenation), late fusion (sequential processing), attention-based fusion, etc.

The generative LLM 1130 and/or other components of the generative LLM system 1100 may use different types of neural network architectures depending on the implementation. Transformer-based architectures such as those used in models like GPT typically include self-attention mechanisms that weigh the importance of different words or tokens in the input sequence and feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1120 may apply an encoded representation of the input 1101 to the generative LLM 1130, and the generative LLM 1130 may process the encoded representation of the input 1101 to generate an output 1190, which may include responsive text and/or other types of data.

FIG. 11B is a block diagram of an example implementation in which the generative LLM 1130 includes a transformer encoder-decoder. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LLM 1130.

In an example implementation, the encoder(s) 1135 form an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example implementation, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example implementation in which the generative LLM 1130 includes a decoder-only transformer architecture. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this implementation). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1333, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1333 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1333. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in the appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in an illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably as far as system may embody one or more methods and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although the discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims. The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

The disclosure of this application also includes the following numbered clauses:

Clause 1. One or more processors comprising processing circuitry to identify one or more frames of image data that depict at least a portion of an interior space of an ego-machine.

Clause 2. The one or more processors of clause 1, wherein the processing circuitry is further to prompt a vision-language model (VLM) to generate one or more responses indicating whether one or more conditions associated with at least one of an operator or an occupant are detected in the one or more frames of image data.

Clause 3. The one or more processors of clause 1 or 2, wherein the processing circuitry is further to control one or more operations of the ego-machine based at least on the one or more responses.

Clause 4. The one or more processors of clause 1, 2 or 3, wherein the VLM is updated using one or more training frames, at least one training frame of the one or more training frames depicting at least one observed operator or occupant, and one or more captions generated by a large language model based at least on metadata associated with the one or more training frames.

Clause 5. The one or more processors of clause 1, 2 or 3, wherein the VLM is updated using one or more captions generated by a large language model based at least on metadata that is associated with one or more training frames and represents at least one of: one or more driver or occupant attributes, one or more instructed actions, or one or more session attributes represented in the one or more training frames.

Clause 6. The one or more processors of clause 1, 2 or 3, wherein the VLM is updated using training data corresponding to at least one of: a plurality of driver monitoring tasks or a plurality of occupant monitoring tasks.

Clause 7. The one or more processors of clause 1, 2 or 3, wherein the processing circuitry is further to periodically prompt the VLM to generate one or more subsequent responses indicating whether the one or more conditions are detected in one or more subsequent frames of image data.

Clause 8. The one or more processors of clause 1, 2 or 3, wherein the processing circuitry is further to prompt the VLM using a representation of the one or more frames sampled from a sliding window of video frames generated using one or more cameras of a driver or occupant monitoring system.

Clause 9. The one or more processors of clause 1, 2 or 3, wherein the one or more responses by the VLM indicate one or more results of at least one of driver drowsiness detection, driver distraction detection, driver or occupant out-of-position detection, driver or occupant identification, seatbelt usage detection, occupant presence detection, occupant classification, child presence detection, or gesture recognition performed by the VLM.

Clause 10. The one or more processors of clause 1, 2 or 3, wherein the one or more responses indicate one or more results of occlusion detection performed by the VLM based at least on the one or more frames of image data representing the operator or occupant.

Clause 11. The one or more processors of clause 1, 2 or 3, wherein the one or more operations of the ego-machine comprise at least one of: issuing an audible or visual alert, adjusting one or more in-vehicle infotainment settings, or activating one or more safety systems.

Clause 12. The one or more processors of clause 1, 2 or 3, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 13. A system comprising one or more processors to control one or more operations of an ego-machine based at least on a vision-language model (VLM) evaluating whether one or more conditions associated with at least one of an operator or an occupant are detected in one or more frames of image data that depict at least a portion of an interior space of the ego-machine.

Clause 14. The system of clause 13, wherein the VLM is updated using one or more training frames, at least one training frame of the one or more training frames depicting at least one observed operator or occupant, and one or more captions generated by a large language model based at least on metadata associated with the one or more training frames.

Clause 15. The system of clause 13, wherein the VLM is updated using one or more captions generated by a large language model based at least on metadata that is associated with one or more training frames and represents at least one of: one or more driver or occupant attributes, one or more instructed actions, or one or more session attributes represented in the one or more training frames.

Clause 16. The system of clause 13, wherein the VLM is updated using training data corresponding to at least one of: a plurality of driver monitoring tasks or a plurality of occupant monitoring tasks.

Clause 17. The system of clause 13, wherein the one or more processors are further to periodically prompt the VLM of the ego-machine to generate one or more subsequent responses that indicate whether the one or more conditions are detected in one or more subsequent frames of image data.

Clause 18. The system of clause 13, wherein the one or more processors are further to prompt the VLM of the ego-machine using a representation of the one or more frames sampled from a sliding window of video frames generated using one or more cameras of a driver or occupant monitoring system.

Clause 19. The system of clause 13, wherein one or more responses by the VLM representing whether the one or more conditions are detected indicate one or more results of at least one of: driver drowsiness detection, driver distraction detection, driver or occupant out-of-position detection, driver or occupant identification, seatbelt usage detection, occupant presence detection, occupant classification, child presence detection, or gesture recognition performed by the VLM.

Clause 20. The system of clause 13, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 21. A method comprising prompting a vision-language model (VLM) of an ego-machine to generate one or more responses representing one or more driver or occupant monitoring tasks.

Clause 22. The method of clause 21, further comprising controlling one or more operations of the ego-machine based at least on the one or more responses.

Clause 23. The method of clause 21 or 22, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 24. One or more processors comprising processing circuitry to identify image data generated using one or more cameras of an ego-machine and representing one or more parking signs.

Clause 25. The one or more processors of clause 24, wherein the processing circuitry is further to prompt a vision-language model (VLM) to generate one or more responses indicating whether parking is permitted in one or more candidate parking spaces based at least on the image data representing the one or more parking signs.

Clause 26. The one or more processors of clause 24 or 25, wherein the processing circuitry is further to control, using an Advanced Driver Assistance System (ADAS) of the ego-machine, one or more parking operations of the ego-machine with respect to at least one candidate parking space of the one or more candidate parking spaces based at least on the one or more responses.

Clause 27. The one or more processors of clause 24, 25 or 26, wherein the processing circuitry is further to initiate monitoring for the one or more parking signs based at least on the ego-machine entering a detected parking mode.

Clause 28. The one or more processors of clause 24, 25 or 26, wherein the processing circuitry is further to detect a parking domain of the ego-machine by performing at least one of: using a mapping application, or prompting the VLM to detect the parking domain based at least on one or more frames comprising at least some of the image data.

Clause 29. The one or more processors of clause 24, 25 or 26, wherein the processing circuitry is further to detect the one or more parking signs based at least on detecting one or more classes of parking signs associated with a detected parking domain of the ego-machine.

Clause 30. The one or more processors of clause 24, 25 or 26, wherein the processing circuitry is further to verify legibility of the one or more parking signs based at least on one or more detected regions of interest representing the one or more parking signs.

Clause 31. The one or more processors of clause 24, 25 or 26, wherein the processing circuitry is further to prompt the VLM to verify legibility of the one or more parking signs.

Clause 32. The one or more processors of clause 24, 25 or 26, wherein the processing circuitry is further to: cache the image data representing the one or more parking signs based at least on verifying legibility of the one or more parking signs, and prompt the VLM to evaluate the cached image data in response to detecting the one or more candidate parking spaces.

Clause 33. The one or more processors of clause 24, 25 or 26, wherein the processing circuitry is further to prompt the VLM to evaluate whether parking is permitted in the one or more candidate parking spaces based at least on one or more geo-tagged parking permits.

Clause 34. The one or more processors of clause 24, 25 or 26, wherein the one or more parking operations of the ego-machine comprise outputting at least one of a visual or an audible representation of whether parking is permitted in the one or more candidate parking spaces.

Clause 35. The one or more processors of clause 24, 25 or 26, wherein the processing circuitry is further to prompt the VLM to determine a cost to park in the one or more candidate parking spaces for a designated duration of time.

Clause 36. The one or more processors of clause 24, 25 or 26, wherein the processing circuitry is further to output at least one of a visual or an audible representation of a cost to park in the one or more candidate parking spaces determined using the VLM.

Clause 37. The one or more processors of clause 24, 25 or 26, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 38. A system comprising one or more processors to control one or more operations of an ego-machine based at least on a vision-language model (VLM) of the ego-machine evaluating whether parking is permitted in one or more candidate parking spaces based at least on image data representing one or more parking signs.

Clause 39. The system of clause 38, wherein the one or more processors are further to initiate monitoring for the one or more parking signs based at least on the ego-machine entering a detected parking mode.

Clause 40. The system of clause 38, wherein the one or more processors are further to detect a parking domain of the ego-machine by performing at least one of: using a mapping application or prompting the VLM to detect the parking domain based at least on one or more frames comprising at least some of the image data.

Clause 41. The system of clause 38, wherein the one or more processors are further to detect the one or more parking signs based at least on monitoring for one or more classes of parking signs associated with a detected parking domain of the ego-machine.

Clause 42. The system of clause 38, wherein the one or more processors are further to verify legibility of the one or more parking signs based at least on one or more detected regions of interest representing the one or more parking signs.

Clause 43. The system of clause 38, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 44. A method comprising prompting a vision-language model (VLM) of an ego-machine to generate one or more responses evaluating one or more scene understanding tasks based at least on image data representing an environment exterior to the ego-machine.

Clause 45. The method of clause 44, further comprising controlling one or more operations of the ego-machine based at least on the one or more responses.

Clause 46. The method of clause 44 or 45, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 47. One or more processors comprising processing circuitry to identify image data generated using one or more cameras of an ego-machine, the image data including a depiction of at least a portion of one or more toll signs.

Clause 48. The one or more processors of clause 47, wherein the processing circuitry is further to prompt a vision-language model (VLM) of the ego-machine to generate one or more responses indicating whether to navigate in one or more toll lanes based at least on the image data representing the one or more toll signs.

Clause 49. The one or more processors of clause 47 or 48, wherein the processing circuitry is further to control one or more operations of the ego-machine based at least on the one or more responses.

Clause 50. The one or more processors of clause 47, 48 or 49, wherein the processing circuitry is further to initiate monitoring for the one or more toll signs based at least on the ego-machine entering a detected highway driving mode.

Clause 51. The one or more processors of clause 47, 48 or 49, wherein the processing circuitry is further to initiate monitoring for the one or more toll signs based at least on the ego-machine entering or approaching one or more geo-tagged locations.

Clause 52. The one or more processors of clause 47, 48 or 49, wherein the processing circuitry is further to prompt the VLM to evaluate the image data representing the one or more toll signs in response to verifying legibility of the one or more toll signs.

Clause 53. The one or more processors of clause 47, 48 or 49, wherein the processing circuitry is further to generate a list of one or more upcoming exits of the one or more toll lanes based at least on verifying legibility of the one or more toll signs.

Clause 54. The one or more processors of clause 47, 48 or 49, wherein the processing circuitry is further to prompt the VLM to determine whether to drive in the one or more toll lanes based at least on a list of one or more upcoming exits of the one or more toll lanes.

Clause 55. The one or more processors of clause 47, 48 or 49, wherein the processing circuitry is further to prompt the VLM to determine whether to drive in the one or more toll lanes based at least on a designated maximum toll.

Clause 56. The one or more processors of clause 47, 48 or 49, wherein the processing circuitry is further to prompt the VLM to determine whether to drive in the one or more toll lanes based at least on a planned exit associated with an active mapping route.

Clause 57. The one or more processors of clause 47, 48 or 49, wherein the processing circuitry is further to prompt the VLM to determine a cost to drive on one or more upcoming segments of the one or more toll lanes based at least on a detected number of occupants of the ego-machine.

Clause 58. The one or more processors of clause 47, 48 or 49, wherein the one or more operations of the ego-machine comprise initiating a merge into or out of the one or more toll lanes.

Clause 59. The one or more processors of clause 47, 48 or 49, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 60. A system comprising one or more processors to control one or more operations of an ego-machine based at least on a vision-language model (VLM) of the ego-machine generating one or more responses indicating whether to drive in one or more toll lanes based at least on image data representing one or more toll signs.

Clause 61. The system of clause 60, wherein the one or more processors are further to initiate monitoring for the one or more toll signs based at least on the ego-machine entering a detected highway driving mode.

Clause 62. The system of clause 60, wherein the one or more processors are further to initiate monitoring for the one or more toll signs based at least on the ego-machine entering or approaching one or more geo-tagged locations.

Clause 63. The system of clause 60, wherein the one or more processors are further to prompt the VLM to evaluate the image data representing the one or more toll signs in response to verifying legibility of the one or more toll signs.

Clause 64. The system of clause 60, wherein the one or more processors are further to generate a list of one or more upcoming exits of the one or more toll lanes based at least on verifying legibility of the one or more toll signs.

Clause 65. The system of clause 60, wherein the one or more processors are further to prompt the VLM to determine whether to drive in the one or more toll lanes based at least on a list of one or more upcoming exits of the one or more toll lanes.

Clause 66. The system of clause 60, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 67. A method comprising prompting a vision-language model (VLM) of an ego-machine to generate one or more responses evaluating one or more signs detected in an environment exterior to the ego-machine.

Clause 68. The method of clause 67, further comprising controlling one or more operations of the ego-machine based at least on the one or more responses.

Clause 69. The method of clause 67 or 68, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 70. One or more processors comprising processing circuitry to queue one or more inference requests representing one or more detection tasks associated with an ego-machine.

Clause 71. The one or more processors of clause 70, wherein the processing circuitry is further to prompt one or more vision-language models (VLMs) of the ego-machine to generate one or more responses evaluating the one or more detection tasks based at least on one or more frames of image data identified by the one or more inference requests.

Clause 72. The one or more processors of clause 70 or 71, wherein the processing circuitry is further to control one or more operations of the ego-machine based at least on the one or more responses.

Clause 73. The one or more processors of clause 70, 71 or 72, wherein the one or more VLMs comprise a first VLM to produce an output corresponding to different types of detection tasks associated with the ego-machine.

Clause 74. The one or more processors of clause 70, 71 or 72, wherein the one or more VLMs comprise a first VLM to produce an output corresponding to one or more interior detection tasks and a second VLM to produce an output corresponding to one or more exterior detection tasks associated with the ego-machine.

Clause 75. The one or more processors of clause 70, 71 or 72, wherein the processing circuitry is further to queue a plurality of inference requests submitted by a plurality of detection applications of the ego-machine.

Clause 76. The one or more processors of clause 70, 71 or 72, wherein the processing circuitry is further to prioritize scheduling the one or more inference requests based at least on an assessed importance of the one or more detection tasks to safety.

Clause 77. The one or more processors of clause 70, 71 or 72, wherein the processing circuitry is further to prioritize scheduling one or more first requests for the one or more VLMs to produce an output corresponding to one or more Advanced Driver Assistance System (ADAS) tasks over one or more second requests for the one or more VLMs to produce an output corresponding to one or more driver or occupant monitoring tasks.

Clause 78. The one or more processors of clause 70, 71 or 72, wherein the processing circuitry is further to prioritize scheduling one or more first requests for the one or more VLMs to produce an output corresponding to one or more exterior detection tasks over one or more second requests for the one or more VLMs to produce an output corresponding to one or more interior detection tasks.

Clause 79. The one or more processors of clause 70, 71 or 72, wherein the one or more detection tasks comprise at least one of driver drowsiness detection, driver distraction detection, driver or occupant out-of-position detection, driver or occupant identification, seatbelt usage detection, occupant presence detection, occupant classification, child presence detection, gesture recognition, sign recognition, context-aware question answering, recognition of one or more objects left behind, or suspicious activity monitoring.

Clause 80. The one or more processors of clause 70, 71 or 72, wherein the one or more responses indicate one or more results of malicious intent detection performed using the one or more VLMs based at least on the one or more frames of image data.

Clause 81. The one or more processors of clause 70, 71 or 72, wherein the one or more operations of the ego-machine comprise at least one of issuing an audible or visual alert, adjusting one or more in-vehicle infotainment settings, activating one or more safety systems, or executing a navigational maneuver.

Clause 82. The one or more processors of clause 70, 71 or 72, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 83. A system comprising one or more processors to control one or more operations of an ego-machine based at least on an inference scheduler prompting one or more vision-language models (VLMs) of an ego-machine to generate one or more responses evaluating one or more detection tasks.

Clause 84. The system of clause 83, wherein the one or more VLMs comprise a first VLM to produce an output corresponding to different types of detection tasks associated with the ego-machine.

Clause 85. The system of clause 83, wherein the one or more VLMs comprise a first VLM to produce an output corresponding to one or more interior detection tasks and a second VLM to produce an output corresponding to one or more exterior detection tasks associated with the ego-machine.

Clause 86. The system of clause 83, wherein the one or more processors are further to queue a plurality of inference requests submitted by a plurality of detection applications of the ego-machine.

Clause 87. The system of clause 83, wherein the one or more processors are further to prioritize scheduling one or more inference requests associated with the one or more VLMs based at least on an assessed importance of the one or more detection tasks to safety.

Clause 88. The system of clause 83, wherein the one or more processors are further to prioritize scheduling one or more first requests for the one or more VLMs to produce an output corresponding to one or more Advanced Driver Assistance System (ADAS) support tasks over one or more second requests for the one or more VLMs to produce an output corresponding to one or more driver or occupant monitoring tasks.

Clause 89. The system of clause 83, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 90. A method comprising prompting, by an inference scheduler, one or more VLMs of an ego-machine to generate one or more responses evaluating one or more detection tasks based at least on one or more frames of image data identified by one or more inference requests.

Clause 91. The method of clause 90, further comprising controlling one or more operations of the ego-machine based at least on the one or more responses.

Clause 92. The method of clause 90 or 91, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

What is claimed is:

1. One or more processors comprising processing circuitry to:
identify image data generated using one or more cameras of an ego-machine, the image data including a depiction of at least a portion of one or more toll signs;
prompt a vision-language model (VLM) of the ego-machine to generate one or more responses indicating whether to navigate in one or more toll lanes based at least on the image data representing the one or more toll signs; and
control one or more operations of the ego-machine based at least on the one or more responses.

2. The one or more processors of claim 1, wherein the processing circuitry is further to initiate monitoring for the one or more toll signs based at least on the ego-machine entering a detected highway driving mode.

3. The one or more processors of claim 1, wherein the processing circuitry is further to initiate monitoring for the one or more toll signs based at least on the ego-machine entering or approaching one or more geo-tagged locations.

4. The one or more processors of claim 1, wherein the processing circuitry is further to prompt the VLM to evaluate the image data representing the one or more toll signs in response to verifying legibility of the one or more toll signs.

5. The one or more processors of claim 1, wherein the processing circuitry is further to generate a list of one or more upcoming exits of the one or more toll lanes based at least on verifying legibility of the one or more toll signs.

6. The one or more processors of claim 5, wherein the processing circuitry is further to prompt the VLM to determine whether to drive in the one or more toll lanes based at least on a list of one or more upcoming exits of the one or more toll lanes.

7. The one or more processors of claim 1, wherein the processing circuitry is further to prompt the VLM to determine whether to drive in the one or more toll lanes based at least on a designated maximum toll.

8. The one or more processors of claim 1, wherein the processing circuitry is further to prompt the VLM to determine whether to drive in the one or more toll lanes based at least on a planned exit associated with an active mapping route.

9. The one or more processors of claim 1, wherein the processing circuitry is further to prompt the VLM to determine a cost to drive on one or more upcoming segments of the one or more toll lanes based at least on a detected number of occupants of the ego-machine.

10. The one or more processors of claim 1, wherein the one or more operations of the ego-machine comprise initiating a merge into or out of the one or more toll lanes.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system for performing one or more generative AI operations;
a system incorporating one or more virtual machines (VMs);
a system implemented at least partially in a data center; or
a system implemented at least partially using cloud computing resources.

12. A system comprising one or more processors to control one or more operations of an ego-machine based at least on a vision-language model (VLM) of the ego-machine generating one or more responses indicating whether to drive in one or more toll lanes based at least on image data representing one or more toll signs.

13. The system of claim 12, wherein the one or more processors are further to initiate monitoring for the one or more toll signs based at least on the ego-machine entering a detected highway driving mode.

14. The system of claim 12, wherein the one or more processors are further to initiate monitoring for the one or more toll signs based at least on the ego-machine entering or approaching one or more geo-tagged locations.

15. The system of claim 12, wherein the one or more processors are further to prompt the VLM to evaluate the image data representing the one or more toll signs in response to verifying legibility of the one or more toll signs.

16. The system of claim 12, wherein the one or more processors are further to generate a list of one or more upcoming exits of the one or more toll lanes based at least on verifying legibility of the one or more toll signs.

17. The system of claim 12, wherein the one or more processors are further to prompt the VLM to determine whether to drive in the one or more toll lanes based at least on a list of one or more upcoming exits of the one or more toll lanes.

18. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system for performing one or more generative AI operations;
a system incorporating one or more virtual machines (VMs);
a system implemented at least partially in a data center; or
a system implemented at least partially using cloud computing resources.

19. A method comprising:
prompting a vision-language model (VLM) of an ego-machine to generate one or more responses evaluating one or more signs detected in an environment exterior to the ego-machine; and
controlling one or more operations of the ego-machine based at least on the one or more responses.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system for performing one or more generative AI operations;
a system incorporating one or more virtual machines (VMs);
a system implemented at least partially in a data center; or
a system implemented at least partially using cloud computing resources.
